(19) United States
(12) Patent Application Publication
(10) Pub. No.: US 2026/0236128 A1
(43) Pub. Date: Aug. 13, 2026

(54) INPUT DEVICE

(71) Applicant: Alps Alpine Co., Ltd., Tokyo (JP)

(72) Inventor: Tetsuo MURANAKA, Miyagi-ken (JP)

(21) Appl. No.: 19/533,998

(22) Filed: Feb. 9, 2026

(30) Foreign Application Priority Data
Feb. 10, 2025 (JP) 2025-020118

(51) Int. Cl. G06F 3/044; G06F 3/0338

(52) U.S. Cl. CPC G06F 3/0446; G06F 3/0338; G06F 2203/04101

(57) ABSTRACT

An input device includes an operation section operable by a hand of an operator, a plurality of electrostatic sensor electrodes disposed around the operation section, a measurement circuit configured to measure a capacitance of each of the plurality of electrostatic sensor electrodes, and a processing unit, in which a storage unit stores reference values that are capacitance values when it is determined that there is no object around the electrostatic sensor electrodes, and the processing unit detects the presence of the hand above the operation section by detecting that each capacitance value of the plurality of electrostatic sensor electrodes has changed by approximately the same amount from a reference value that is a capacitance value when the hand is not present.

### CLAIM OF PRIORITY

This application claims benefit of Japanese Patent Application No. 2025-020118 filed on Feb. 10, 2025, which is hereby incorporated by reference.

### BACKGROUND OF THE INVENTION

### 1. Field of the Invention

The present invention relates to an input device.

### 2. Description of the Related Art

U.S. Pat. No. 12,138,531 B2 discloses a technique for detecting a finger that has approached the surface of an operation button by using a detection conductor provided for the operation button.

In the technique in U.S. Pat. No. 12,138,531 B2, however, the detection conductor is disposed directly beneath the operation button, and a finger present at a lateral side of the operation button may be detected by the detection conductor. In addition, in the technique in U.S. Pat. No. 12,138,531 B2, the detection conductor moves together with the operation button, and the detection range of the detection conductor changes depending on the state of the button such as the position, the amount pressed, or the like.

### SUMMARY OF THE INVENTION

The present invention provides an input device including an operation section operable by a hand of an operator, a plurality of electrostatic sensor electrodes disposed around the operation section, a measurement circuit configured to measure a capacitance of each of the plurality of electrostatic sensor electrodes, and a processing unit, in which a storage unit stores reference values that are capacitance values when it is determined that there is no object around the electrostatic sensor electrodes, and the processing unit detects the presence of the hand above the operation section by detecting that each capacitance value of the plurality of electrostatic sensor electrodes has changed by approximately the same amount from a reference value that is a capacitance value when the hand is not present.

An input device according to one embodiment can achieve highly accurate detection of the presence of a hand above an operation section without providing an electrostatic sensor electrode beneath the operation section.

### BRIEF DESCRIPTION OF THE DRAWINGS

FIG. 1 is a diagram illustrating an example (first example) arrangement of buttons and electrostatic sensor electrodes in an input device according to one embodiment;

FIG. 2 is a diagram illustrating a configuration of a control system in the input device according to one embodiment;

FIG. 3 is a flowchart illustrating an example (first example) processing procedure to be performed by a processing unit in the input device according to one embodiment;

FIG. 4 is a diagram illustrating an example range of detecting an operator's hand by the input device according to one embodiment;

FIG. 5 is a flowchart illustrating an example (second example) processing procedure to be performed by the processing unit in the input device according to one embodiment;

FIG. 6 is a flowchart illustrating the example (second example) processing procedure to be performed by the processing unit in the input device according to one embodiment;

FIG. 7 is a flowchart illustrating an example procedure of hysteresis processing to be performed by the processing unit in the input device according to one embodiment;

FIG. 8 is a flowchart illustrating an example (third example) processing procedure to be performed by the processing unit in the input device according to one embodiment;

FIG. 9 is a flowchart illustrating an example (fourth example) processing procedure to be performed by the processing unit in the input device according to one embodiment;

FIG. 10 is a flowchart illustrating an example (fifth example) processing procedure to be performed by the processing unit in the input device according to one embodiment;

FIG. 11 is a diagram illustrating an example (second example) arrangement of buttons and electrostatic sensor electrodes in the input device according to one embodiment;

FIG. 12 is a diagram illustrating an example (third example) arrangement of buttons and electrostatic sensor electrodes in the input device according to one embodiment;

FIG. 13 is a diagram illustrating an example (fourth example) arrangement of buttons and electrostatic sensor electrodes in the input device according to one embodiment;

FIG. 14 is a diagram illustrating an example (fifth example) arrangement of buttons and electrostatic sensor electrodes in the input device according to one embodiment;

FIG. 15 is a diagram illustrating an example (sixth example) arrangement of buttons and electrostatic sensor electrodes in the input device according to one embodiment;

FIG. 16 is a diagram illustrating an example (seventh example) arrangement of buttons and electrostatic sensor electrodes in the input device according to one embodiment;

FIG. 17 is a diagram illustrating an example (eighth example) arrangement of buttons and electrostatic sensor electrodes in the input device according to one embodiment;

FIG. 18 is a diagram illustrating an example (ninth example) arrangement of buttons and electrostatic sensor electrodes in the input device according to one embodiment;

FIG. 19 is a diagram illustrating an example (tenth example) arrangement of buttons and electrostatic sensor electrodes in the input device according to one embodiment;

FIG. 20 is a diagram illustrating an example (eleventh example) arrangement of buttons and electrostatic sensor electrodes in the input device according to one embodiment;

FIG. 21 is a diagram illustrating an example (twelfth example) arrangement of buttons and electrostatic sensor electrodes in the input device according to one embodiment; and FIG. 22 is a diagram illustrating another example configuration of the control system in the input device according to one embodiment.

### DESCRIPTION OF THE PREFERRED EMBODIMENTS

Hereinafter, one embodiment will be described with reference to the attached drawings. In the following description, for convenience, the Z-axis direction in the drawings denotes the up-down direction, the Y-axis direction in the drawings denotes the left-right direction, and the X-axis direction in the drawings denotes the front-back direction, in which, the positive Z-axis direction denotes the upward direction, the positive Y-axis direction denotes the rightward direction, and the positive X-axis direction denotes the forward direction.

### Example of Arrangement of Buttons and Electrostatic Sensor Electrodes

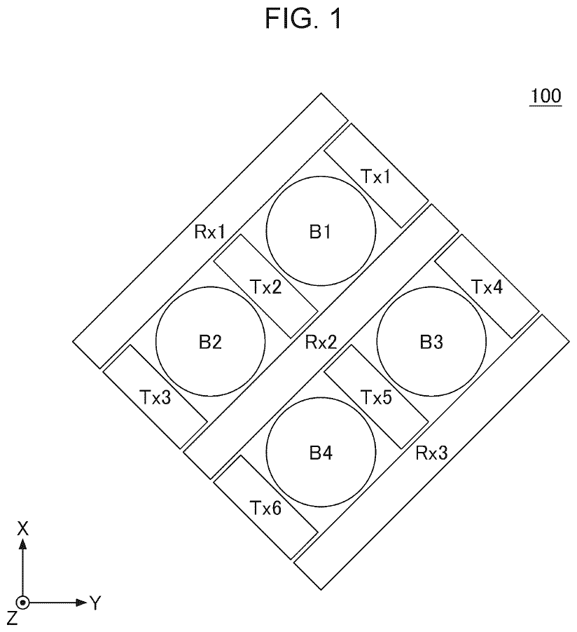

FIG. 1 is a diagram illustrating an example (first example) arrangement of buttons and electrostatic sensor electrodes in an input device 100 according to one embodiment. FIG. 1 is a diagram of the input device 100 from above (the positive Z-axis direction), illustrating an arrangement of a plurality of buttons and a plurality of electrostatic sensor electrodes in the input device 100.

In the example illustrated in FIG. 1, the input device 100 includes four buttons B1, B2, B3, and B4. Each of the buttons B1 to B4 is an example of an “operation section” and a “push button”. Each of the buttons B1 to B4 is a resin member that is provided to be movable in the up-down direction (Z-axis direction) and is operable by a hand of an operator through a pressing operation. Each of the buttons B1 to B4 has a circular shape when viewed from above (positive Z-axis direction). The four buttons B1 to B4 are disposed in a cross shape when viewed from above (in the positive Z-axis direction). More specifically, the buttons B1, B2, B3, and B4 are disposed, with respect to the center of the input device 100, on the front side (in the positive X-axis direction), the left side (in the negative Y-axis direction), the right side (in the positive Y-axis direction), and the back side (in the negative X-axis direction), respectively. Each of the buttons B1 to B4 is configured to, in response to a press operation, output a signal indicating that the pressing operation has been performed.

In the example illustrated in FIG. 1, the input device 100 includes nine electrostatic sensor electrodes Rx1, Rx2, Rx3, Tx1, Tx2, Tx3, Tx4, Tx5, and Tx6. Tx1, Tx2, Tx3, Tx4, Tx5, and Tx6 are used for driving in mutual capacitance-type capacitance detection, whereas Rx1, Rx2, and Rx3 are used for detection in mutual capacitance-type capacitance detection.

Each of the electrostatic sensor electrodes Rx1 to Rx3 and Tx1 to Tx6 is a flat-shaped member made of conductive material. Each of the electrostatic sensor electrodes Rx1 to Rx3 and Tx1 to Tx6 is, for example, disposed on a substrate. Each of the electrostatic sensor electrodes Rx1 to Rx3 and Tx1 to Tx6 has a rectangular shape when viewed from above (in the positive Z-axis direction). The electrostatic sensor electrodes Rx1 to Rx3 and Tx1 to Tx6 are disposed around the corresponding four buttons B1 to B4 so as to surround the four buttons B1 to B4 respectively.

More specifically, the electrostatic sensor electrode Rx1, the electrostatic sensor electrode Rx2, and the electrostatic sensor electrode Rx3 are disposed parallel to each other. Each of the electrostatic sensor electrode Rx1, the electrostatic sensor electrode Rx2, and the electrostatic sensor electrode Rx3 has a strip shape extending diagonally from the front right to the back left.

Between the electrostatic sensor electrode Rx1 and the electrostatic sensor electrode Rx2, the electrostatic sensor electrode Tx1, the button B1, the electrostatic sensor electrode Tx2, the button B2, and the electrostatic sensor electrode Tx3 are disposed in a row diagonally from the front right to the back left.

Among these, each of the electrostatic sensor electrode Tx1 and the electrostatic sensor electrode Tx2 has a strip shape extending diagonally from the front left to the back right, and the electrodes are disposed parallel to each other with the button B1 disposed between the electrodes.

Each of the electrostatic sensor electrode Tx2 and the electrostatic sensor electrode Tx3 has a strip shape extending diagonally from the front left to the back right, and the electrodes are disposed parallel to each other with the button B2 disposed between the electrodes.

Between the electrostatic sensor electrode Rx2 and the electrostatic sensor electrode Rx3, the electrostatic sensor electrode Tx4, the button B3, the electrostatic sensor electrode Tx5, the button B4, and the electrostatic sensor electrode Tx6 are disposed in a row diagonally from the front right to the back left.

Among these, each of the electrostatic sensor electrode Tx4 and the electrostatic sensor electrode Tx5 has a strip shape extending diagonally from the front left to the back right, and the electrodes are disposed parallel to each other with the button B3 disposed between the electrodes.

Each of the electrostatic sensor electrode Tx5 and the electrostatic sensor electrode Tx6 has a strip shape extending diagonally from the front left to the back right, and the electrodes are disposed parallel to each other with the button B4 disposed between the electrodes.

In other words, in the configuration in FIG. 1, for one button (operation section), two electrostatic sensor electrodes for driving in mutual capacitance-type capacitance detection that are disposed oppositely, and two electrostatic sensor electrodes for detection in mutual capacitance-type capacitance detection that are disposed oppositely are provided.

### Configuration of Control System in Input Device 100

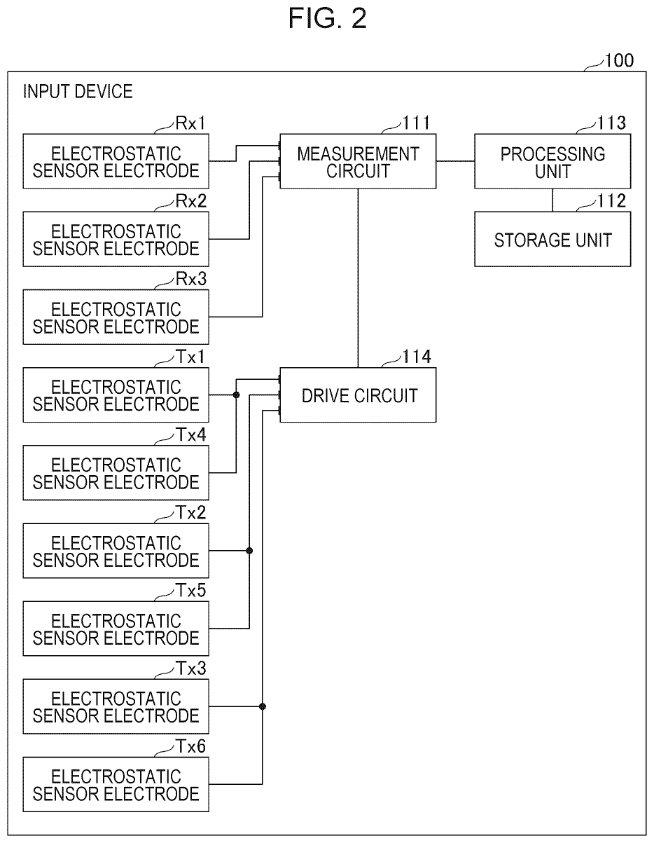

FIG. 2 is a diagram illustrating a configuration of a control system in the input device 100 according to one embodiment. As illustrated in FIG. 2, the control system in the input device 100 includes a measurement circuit 111, a drive circuit 114, a storage unit 112, and a processing unit 113.

The measurement circuit 111 is electrically connected to each of the electrostatic sensor electrodes Rx1 to Rx3. The drive circuit 114 is electrically connected to each of the electrostatic sensor electrodes Tx1 to Tx6. The drive circuit 114 drives the electrostatic sensor electrodes Tx1 to Tx6 by supplying driving current to the electrostatic sensor electrodes Tx1 to Tx6. The measurement circuit 111 detects capacitance values between respective driving electrostatic sensor electrodes Tx1 to Tx6 and corresponding detection electrostatic sensor electrodes Rx1 to Rx3 in the mutual capacitance method. The closer the distance between an electrostatic sensor electrode and a hand of an operator, the greater the capacitive coupling between the electrostatic sensor electrode and the hand of the operator. Accordingly, the capacitance value detected between each pair of electrostatic sensor electrodes by the measurement circuit 111 increases as the distance between the electrostatic sensor electrode and the hand of the operator decreases.

Among the drive electrostatic sensor electrodes Tx1 to Tx6, some of the electrostatic sensor electrodes Tx1 to Tx6 disposed in a straight line may be electrically connected to each other. More specifically, Tx1 and Tx4 may be connected, Tx2 and Tx5 may be connected, and Tx3 and Tx6 may be connected. The electrostatic sensor electrodes Tx1 to Tx6 are driven sequentially and measurements are performed by the detection electrostatic sensor electrodes Rx1 to Rx3. More specifically, first, an alternating current is applied to the drive electrostatic sensor electrodes Tx1 and Tx4, and capacitance values are measured by the detection electrostatic sensor electrodes Rx1 to Rx3. Next, an alternating current is applied to the drive electrostatic sensor electrodes Tx2 and Tx5, and capacitance values are measured by the detection electrostatic sensor electrodes Rx1 to Rx3. Finally, an alternating current is applied to the drive electrostatic sensor electrodes Tx3 and Tx6, and capacitance values are measured by the detection electrostatic sensor electrodes Rx1 to Rx3. After that, the measurement of capacitance values is repeated by sequentially driving the drive electrostatic sensor electrodes Tx1 to Tx6 and measuring capacitance values by using the detection electrostatic sensor electrodes Rx1 to Rx3.

The storage unit 112 stores various types of information. For example, the storage unit 112 stores reference values that are capacitance values in a state in which it is determined that there is no object around the respective electrostatic sensor electrodes Rx1 to Rx3, and Tx1 to Tx6. The storage unit 112 may be a random access memory (RAM).

The processing unit 113 executes various computation processes. For example, the processing unit 113 executes processing to detect the presence of an operator's hand above each of the buttons B1 to B4 based on capacitance values between corresponding electrostatic sensor electrodes detected by the measurement circuit 111. The processing unit 113 may be, for example, a central processing unit (CPU), an integrated circuit (IC), or the like.

### First Example of Processing Procedure Performed by Processing Unit 113

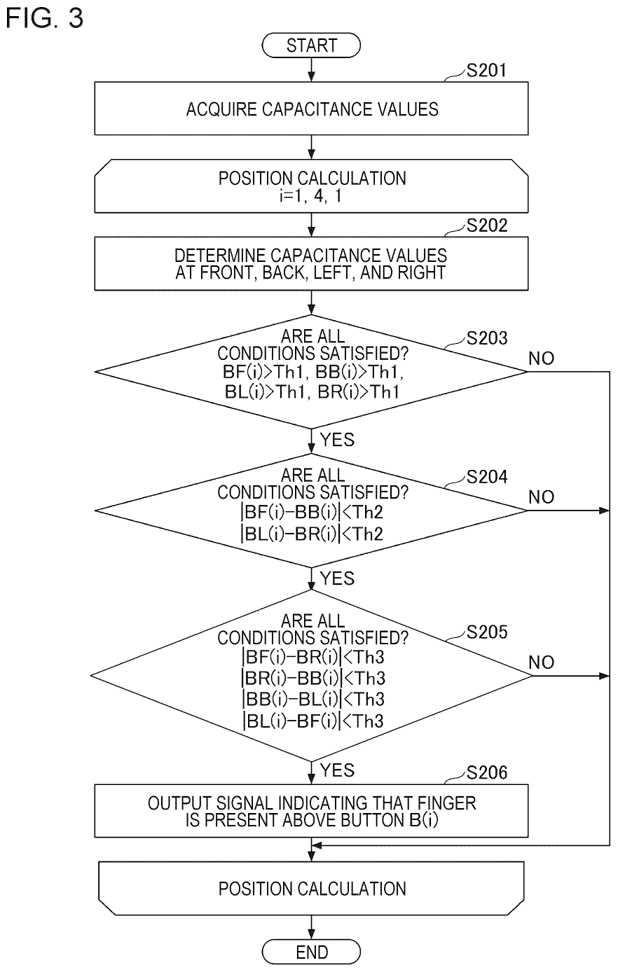

FIG. 3 is a flowchart illustrating an example (first example) processing procedure to be performed by the processing unit 113 in the input device 100 according to one embodiment.

First, the processing unit 113 acquires capacitance values between corresponding electrostatic sensor electrodes measured by the measurement circuit 111 (step S201).

Next, the processing unit 113 repeatedly performs steps S202 to S206 as position calculation processing. Here, the number of buttons is set to “4”, and a variable i indicating a button B(i) to be processed is set such that its start value is “1”, its end value is “4”, and its increment is “1”. In step S202, the processing unit 113 determines capacitance values at the front, back, left, and right of the button B(i) to be processed (step S202).

For example, when a button B(1) is the processing target, the processing unit 113 determines, with respect to the button B(1), a mutual capacitance value between the electrostatic sensor electrodes Tx1 and Rx1 as a forward capacitance value BF(i), a mutual capacitance value between the electrostatic sensor electrodes Tx2 and Rx2 as a backward capacitance value BB(i), a mutual capacitance value between the electrostatic sensor electrodes Tx2 and Rx1 as a leftward capacitance value BL(i), and a mutual capacitance value between the electrostatic sensor electrodes Tx1 and Rx2 as a rightward capacitance value BR(i).

For example, when a button B(2) is the processing target, the processing unit 113 determines, with respect to the button B(2), a mutual capacitance value between the electrostatic sensor electrodes Tx2 and Rx1 as a forward capacitance value BF(i), a mutual capacitance value between the electrostatic sensor electrodes Tx3 and Rx2 as a backward capacitance value BB(i), a mutual capacitance value between the electrostatic sensor electrodes Tx3 and Rx1 as a leftward capacitance value BL(i), and a mutual capacitance value between the electrostatic sensor electrodes Tx2 and Rx2 as a rightward capacitance value BR(i).

For example, when a button B(3) is the processing target, the processing unit 113 determines, with respect to the button B(3), a mutual capacitance value between the electrostatic sensor electrodes Tx4 and Rx2 as a forward capacitance value BF(i), a mutual capacitance value between the electrostatic sensor electrodes Tx5 and Rx3 as a backward capacitance value BB(i), a mutual capacitance value between the electrostatic sensor electrodes Tx5 and Rx2 as a leftward capacitance value BL(i), and a mutual capacitance value between the electrostatic sensor electrodes Tx4 and Rx3 as a rightward capacitance value BR(i).

For example, when a button B(4) is the processing target, the processing unit 113 determines, with respect to the button B(4), a mutual capacitance value between the electrostatic sensor electrodes Tx5 and Rx2 as a forward capacitance value BF(i), a mutual capacitance value between the electrostatic sensor electrodes Tx6 and Rx3 as a backward capacitance value BB(i), a mutual capacitance value between the electrostatic sensor electrodes Tx6 and Rx2 as a leftward capacitance value BL(i), and a mutual capacitance value between the electrostatic sensor electrodes Tx5 and Rx3 as a rightward capacitance value BR(i).

In step S203, the processing unit 113 determines whether a condition 1 is satisfied, that is, whether “all capacitance values (BF(i), BB(i), BL(i), BR(i)) at the front, back, left, and right of the button B(i) are higher than a predetermined first threshold Th1” is satisfied (step S203).

The condition 1 and the first threshold Th1 are used to determine whether the operator's finger is in proximity to a button B(i). The first threshold Th1 is set to an appropriate value obtained through simulation or the like, and is stored in the storage unit 112.

In step S203, when it is determined that the condition 1 is satisfied (step S203: YES), the processing unit 113 proceeds to step S204. In step S203, when it is determined that the condition 1 is not satisfied (step S203: NO), the processing unit 113 terminates the position calculation processing for the button B(i).

In step S204, the processing unit 113 determines whether a condition 2 is satisfied, that is, whether “both the absolute value of the difference between the front and back capacitance values (|BF(i)−BB(i)|) of the button B(i) and the absolute value of the difference between the left and right capacitance values (|BL(i)−BR(i)|) of the button B(i) are lower than a predetermined threshold Th2” is satisfied (step S204).

The condition 2 and the threshold Th2 are used to exclude cases in which the operator's finger is present at a lateral side of the button B(i), based on the absolute values of the differences between the two opposing capacitance values. The threshold Th2 is set to an appropriate value obtained through simulation or the like, and is stored in the storage unit 112.

In step S204, when it is determined that the condition 2 is satisfied (step S204: YES), the processing unit 113 proceeds to step S205. In step S204, when it is determined that the condition 2 is not satisfied (step S204: NO), the processing unit 113 terminates the position calculation processing for the button B(i).

In step S205, the processing unit 113 determines whether a condition 3 is satisfied, that is, whether “the absolute value of the difference between the front and right capacitance values (|BF(i)−BR(i)|) of the button B(i), the absolute value of the difference between the right and back capacitance values (|BR(i)−BB(i)|) of the button B(i), the absolute value of the difference between the back and left capacitance values (|BB(i)−BL(i)|) of the button B(i), and the absolute value of the difference between the left and front capacitance values (|BL(i)−BF(i)|) of the button B(i) are all lower than a predetermined threshold Th3” is satisfied (step S205).

The condition 3 and the threshold Th3 are used to exclude cases in which the operator's finger is present at a lateral side of the button B(i), based on the absolute values of the differences between the two adjacent capacitance values. The threshold Th3 is less than the threshold Th2, is set to an appropriate value obtained through simulation or the like, and is stored in the storage unit 112.

In step S205, when it is determined that the condition 3 is satisfied (step S205: YES), the processing unit 113 outputs a signal indicating that the finger is present above the button B(i) (step S206), and terminates the position calculation processing for the button B(i). In step S205, when it is determined that the condition 3 is not satisfied (step S205: NO), the processing unit 113 terminates the position calculation processing for the button B(i).

After executing all position calculation processing for the buttons B1 to B4, the processing unit 113 terminates the series of processes in FIG. 3. However, the processing unit 113 may repeatedly execute the series of processes illustrated in FIG. 3. For example, during a specific game execution, when none of the buttons B(1) to B(4) are pressed, the processing unit 113 may repeatedly execute the series of processes in FIG. 3.

According to the flowchart illustrated in FIG. 3, by using the each of capacitance values (first branch process) and the differences of capacitance values (second and third branch processes), it is possible to detect the presence of an operator's hand above a button while preventing detection of the presence of an operator's hand at a lateral side of the button, by using the plurality of electrostatic sensor electrodes disposed around the button, without providing a sensor electrode beneath the button.

### Example of Range of Detecting Operator's Hand by Input Device 100

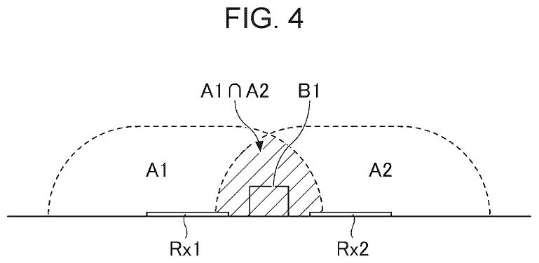

FIG. 4 is a diagram illustrating an example of a range of detecting an operator's hand by the input device 100 according to one embodiment. In FIG. 4, as an example, the button B1, the electrostatic sensor electrode Rx1 of the self-capacitance type, and the electrostatic sensor electrode Rx2 of the self-capacitance type are used.

A detection range A1 illustrated in FIG. 4 indicates a detection range in which the capacitance value of the electrostatic sensor electrode Rx1 becomes greater than or equal to a first threshold Th1. A detection range A2 illustrated in FIG. 4 indicates a detection range in which the capacitance value of the electrostatic sensor electrode Rx2 becomes greater than or equal to the first threshold Th1.

That is, a region A1∩A2, which includes the button B1 hatched in FIG. 4, is a region in which the detection ranges A1 and A2 overlap. When an operator's hand is present in the region A1∩A2, capacitance values of both electrostatic sensor electrodes Rx1 and Rx2 become greater than or equal to the first threshold Th1. Note that the region A1∩A2 is an example of a “lower space”.

Accordingly, when the condition 1 is satisfied, the processing unit 113 can determine that an operator's hand is present in the region A1∩A2.

In other words, when the capacitance values of the plurality of electrostatic sensor electrodes disposed around the button are greater than the first threshold Th1, the processing unit 113 determines that an operator's hand is present in the region A1∩A2 (lower space).

Accordingly, the processing unit 113 can determine, through relatively simple calculations, that an operator's hand is present in the region A1∩A2 (lower space).

However, the foregoing is not limited to thereto. For example, when the sum or product of the capacitance values of a plurality of electrostatic sensor electrodes provided around the button is greater than the first threshold Th1, the processing unit 113 may determine that an operator's hand is present in the region A1∩A2 (lower space). Also in this case, the processing unit 113 can determine, through relatively simple calculations, that an operator's hand is present in the region A1∩A2 (lower space).

However, by using only the condition 1, the processing unit 113 cannot distinguish between a case in which an operator's hand is present above the button B1 and a case in which an operator's hand is present at a lateral side of the button B1 in the region A1∩A2.

Here, when the operator's hand is present above button B1 in the region A1∩A2, the distances between the respective electrostatic sensor electrodes Rx1 and Rx2 and the operator's hand become approximately equal, and thus the capacitance values of the electrostatic sensor electrodes Rx1 and Rx2 become approximately equal. In other words, the absolute values of the differences between the capacitance values of the electrostatic sensor electrodes Rx1 and Rx2 become less than the threshold Th2.

On the other hand, when the operator's hand is present at a lateral side of the button B1 in the region A1∩A2, the distances between the respective electrostatic sensor electrodes Rx1 and Rx2 and the operator's hand differ largely, and thus capacitance values of the electrostatic sensor electrodes Rx1 and Rx2 differ largely. In other words, the absolute values of the differences between the capacitance values of the electrostatic sensor electrodes Rx1 and Rx2 become larger than the threshold Th2.

Accordingly, when the absolute values of the differences between the capacitance values of the electrostatic sensor electrode Rx1 and the capacitance values of the electrostatic sensor electrode Rx2 are less than the threshold Th2 (that is, when the condition 2 is satisfied), the processing unit 113 determines that the operator's hand is present above the button B1. Conversely, when the absolute values of the differences between the capacitance values of the electrostatic sensor electrode Rx1 and the capacitance values of the electrostatic sensor electrode Rx2 are greater than or equal to the threshold Th2, the processing unit 113 determines that the operator's hand is present at a lateral side of the button B1 and excludes the detection. With this processing, the processing unit 113 can determine, through relatively simple calculations, that the operator's hand is present above the button B1.

However, the foregoing is not limited to thereto. For example, when the ratio between the capacitance values of the electrostatic sensor electrode Rx1 and the capacitance values of the electrostatic sensor electrode Rx2 is less than the threshold Th2, the processing unit 113 may determine that the operator's hand is present above the button B1. Also in this case, the processing unit 113 can determine, through relatively simple calculations, that the operator's hand is present above the button B1.

Alternatively, for example, the processing unit 113 may determine that the operator's hand is present above the button B1 when both capacitance values of the electrostatic sensor electrodes Rx1 and Rx2 are less than the second threshold Th2. Also in this case, the processing unit 113 can determine, through relatively simple calculations, that the operator's hand is present above the button B1.

As described above, the processing unit 113 detects the presence of an operator's hand above a button (operation section) by detecting that each capacitance value of a plurality of electrostatic sensor electrodes has changed by approximately the same amount from the reference value, which is the capacitance value when no hand is present, that is, by detecting that the conditions 1 to 3 described above are all satisfied. Accordingly, the input device 100 according to one embodiment can detect with high accuracy the presence of a hand above a button (operation section) without providing an electrostatic sensor electrode beneath the button (operation section).

In particular, by executing the flow illustrated in FIG. 3, the processing unit 113 determines the presence of an operator's hand above a button (operation section) in the region A1∩A2 (lower space), among the four electrostatic sensor electrodes disposed adjacent to each other at 90-degree intervals around the button (operation section), when the differences between the capacitance values of two electrostatic sensor electrodes disposed opposite to each other across the button (operation section) are less than the second threshold Th2 respectively, and the differences between the capacitance values of two electrostatic sensor electrodes disposed adjacent to each other at positions that differ by 90 degrees are less than the third threshold Th3 respectively. Through this processing, the processing unit 113 can determine with high accuracy whether an operator's hand is present above the button (operation section).

Note that the flow illustrated in FIG. 3 may be modified such that the processing unit 113 determines the presence of an operator's hand above the button (operation section) in the region A1∩A2 (lower space) when the differences between the capacitance values of two electrostatic sensor electrodes disposed opposite to each other are less than the second threshold Th2 respectively. In other words, the determination processing based on the differences between the capacitance values of two adjacent electrostatic sensor electrodes may be omitted. Also in this case, the processing unit 113 can determine with high accuracy whether an operator's hand is present above the button (operation section).

Alternatively, the flow illustrated in FIG. 3 may be modified such that the processing unit 113 determines the presence of an operator's hand above the button (operation section) in the region A1∩A2 (lower space) when the differences between the capacitance values of two adjacent electrostatic sensor electrodes are less than the third threshold Th3. In other words, the determination processing based on the differences between the capacitance values of two electrostatic sensor electrodes disposed opposite to each other may be omitted. Also in this case, the processing unit 113 can determine with high accuracy whether an operator's hand is present above the button (operation section).

In addition, by executing the flow illustrated in FIG. 3, the processing unit 113 can determine individually for each of the plurality of buttons (operation sections) whether an operator's hand is present above the button (operation section) in the region A1∩A2 (lower space).

### Second Example of Processing Procedure Performed by Processing Unit 113

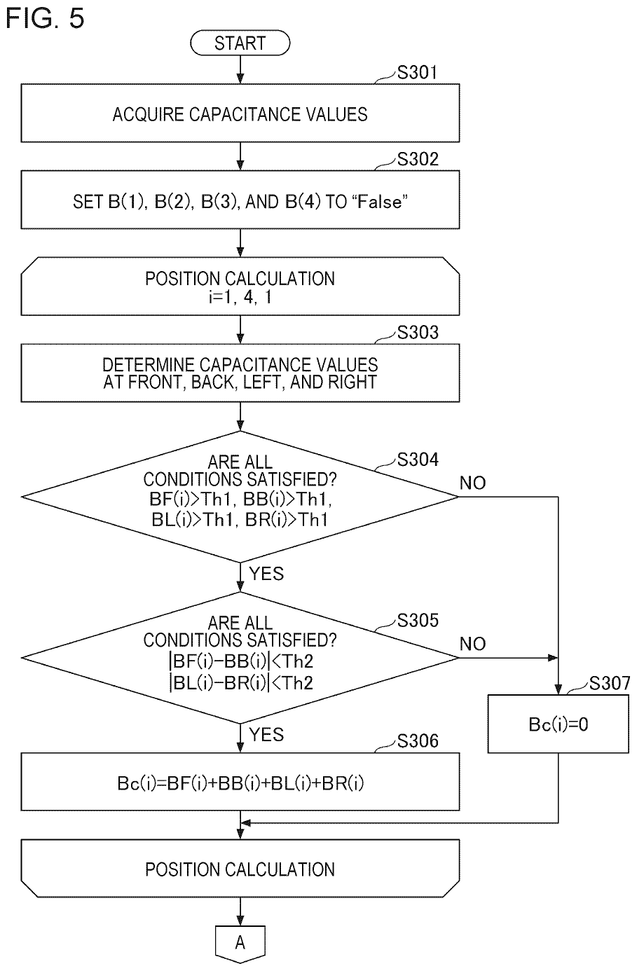

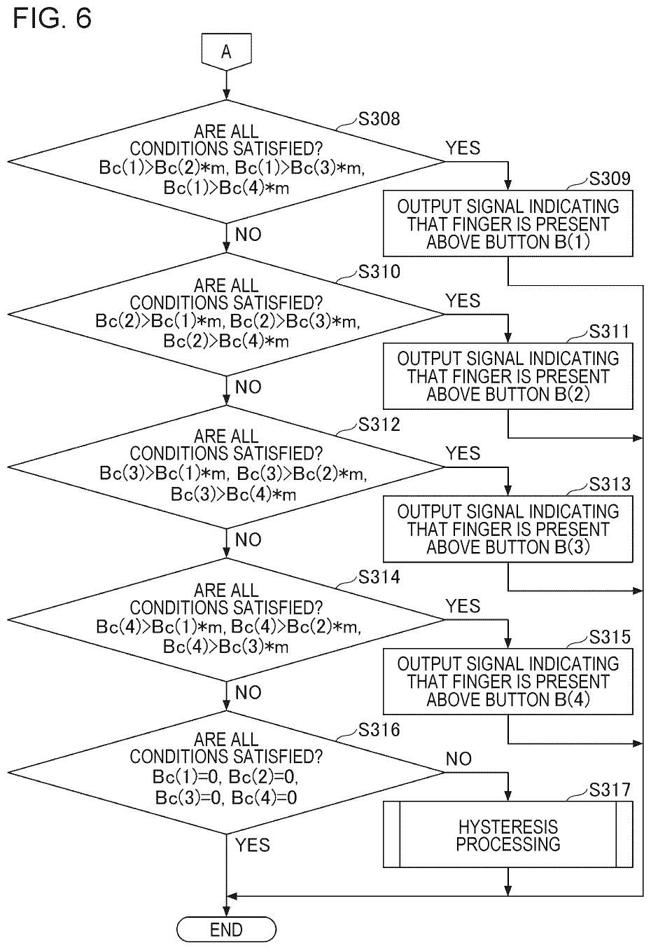

FIG. 5 and FIG. 6 are flowcharts illustrating an example (second example) processing procedure to be performed by the processing unit 113 in the input device 100 according to one embodiment.

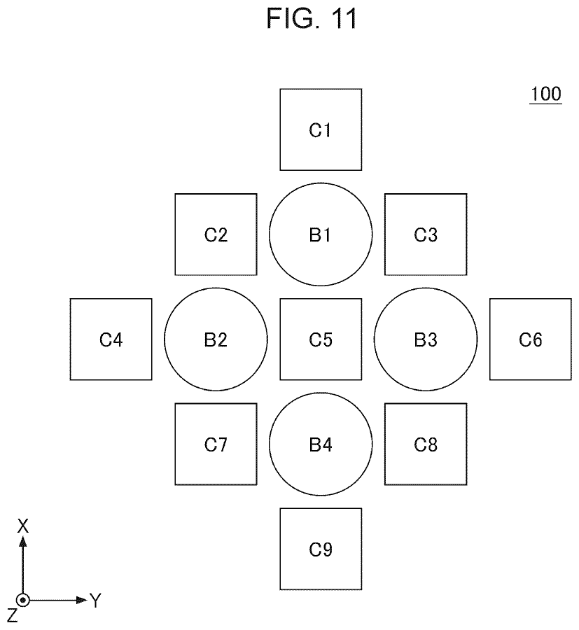

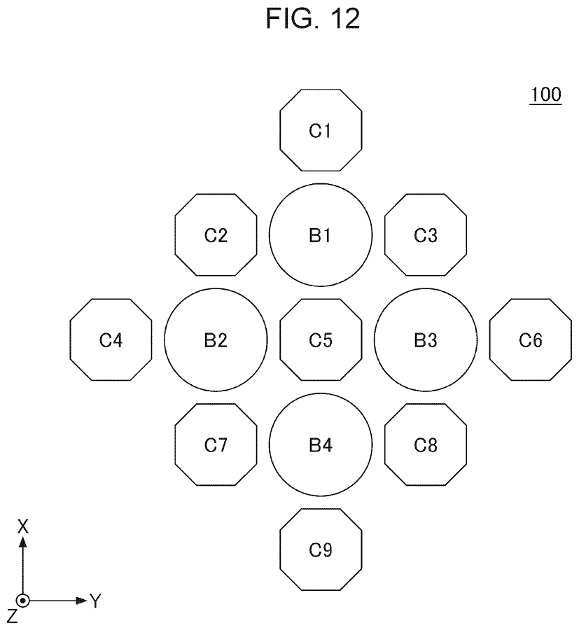

First, the processing unit 113 acquires capacitance values of electrostatic sensor electrodes measured by the measurement circuit 111 (step S301). Each of the electrostatic sensors may be an electrostatic sensor of the mutual-capacitance type illustrated in FIG. 1 or an electrostatic sensor of the self-capacitance type (see FIGS. 11 to 21).

Next, the processing unit 113 sets each of variables B(1), B(2), B(3), and B(4) to “False” (step S302).

Next, the processing unit 113 repeatedly executes steps S303 to S307 as position calculation processing. Here, the number of buttons is set to “4”, and a variable i indicating a button B(i) to be processed is set such that its start value is “1”, its end value is “4”, and its increment is “1”.

In step S303, the processing unit 113 determines front, back, left, and right capacitance values of the button B(i) to be processed, in the same manner as in step S202 in FIG. 3 (step S303).

In step S304, the processing unit 113 determines whether a condition 1 is satisfied, that is, whether “all capacitance values (BF(i), BB(i), BL(i), BR(i)) at the front, back, left, and right of the button B(i) are higher than a predetermined first threshold Th1” is satisfied (step S304). In step S304, when it is determined that the condition 1 is satisfied (step S304: YES), the processing unit 113 proceeds to step S305. In step S304, when it is determined that the condition 1 is not satisfied (step S304: NO), the processing unit 113 sets the variable Bc(i) to “0” (step S307) and terminates the position calculation processing for the button B(i). The variable Bc(i)=0 indicates that no finger is present above the button B(i).

In step S305, the processing unit 113 determines whether a condition 2 is satisfied, that is, whether “both the absolute value of the difference between the front and back capacitance values (|BF(i)−BB(i)|) of the button B(i) and the absolute value of the difference between the left and right capacitance values (|BL(i)−BR(i)|) of the button B(i) are lower than a predetermined threshold Th2” is satisfied (step S305).

In step S305, when it is determined that the condition 2 is satisfied (step S305: YES), the processing unit 113 sets Bc(i) to BF(i)+BB(i)+BL(i)+BR(i) (step S306) and then terminates the position calculation processing for the button B(i). In step S305, when it is determined that the condition 2 is not satisfied (step S305: NO), the processing unit 113 sets the variable Bc(i) to “0” (step S307) and terminates the position calculation processing for the button B(i).

After executing all position calculation processes for the buttons B1 to B4, the processing unit 113 proceeds to step S308 in FIG. 6.

In step S308, the processing unit 113 determines whether all three conditions, Bc(1)>Bc(2)* m, Bc(1)>Bc(3)* m, and Bc(1)>Bc(4)* m, are satisfied (step S308). Here, m is a coefficient, and as one example, “1.1” (i.e., +10%) is set.

In step S308, when it is determined that all of the three conditions are satisfied (step S308: YES), that is, when Bc(1) is greater than each of the others by 10% or more, the processing unit 113 outputs a signal indicating that a finger is present above the button B(1) (step S309), and then terminates the series of processes illustrated in FIGS. 5 and 6.

In step S308, when it is determined that not all of the three conditions are satisfied (step S308: NO), the processing unit 113 determines whether all three conditions, Bc(2)>Bc(1)*m, Bc(2)>Bc(3)*m, and Bc(2)>Bc(4)*m, are satisfied (step S310). Here, m is a coefficient, and as one example, “1.1” (i.e., +10%) is set.

In step S310, when it is determined that all of the three conditions are satisfied (step S310: YES), that is, when Bc(2) is greater than each of the others by 10% or more, the processing unit 113 outputs a signal indicating that a finger is present above the button B(2) (step S311), and then terminates the series of processes illustrated in FIGS. 5 and 6. In step S310, when it is determined that not all of the three conditions are satisfied (step S310: NO), the processing unit 113 determines whether all three conditions, Bc(3)>Bc(1)*m, Bc(3)>Bc(2)*m, and Bc(3)>Bc(4)*m, are satisfied (step S312). Here, m is a coefficient, and as one example, “1.1” (i.e., +10%) is set.

In step S312, when it is determined that all of the three conditions are satisfied (step S312: YES), that is, when Bc(3) is greater than each of the others by 10% or more, the processing unit 113 outputs a signal indicating that a finger is present above the button B(3) (step S313), and then terminates the series of processes illustrated in FIGS. 5 and 6. In step S312, when it is determined that not all of the three conditions are satisfied (step S312: NO), the processing unit 113 determines whether all three conditions, Bc(4)>Bc(1)*m, Bc(4)>Bc(2)*m, and Bc(4)>Bc(3)*m, are satisfied (step S314). Here, m is a coefficient, and as one example, “1.1” (i.e., +10%) is set.

In step S314, when it is determined that all of the three conditions are satisfied (step S314: YES), that is, when Bc(4) is greater than each of the others by 10% or more, the processing unit 113 outputs a signal indicating that a finger is present above the button B(4) (step S315), and then terminates the series of processes illustrated in FIGS. 5 and 6. In step S314, when it is determined that not all of the three conditions are satisfied (step S314: NO), the processing unit 113 determines whether all four conditions, Bc(1)=0, Bc(2)=0, Bc(3)=0, and Bc(4)=0, are satisfied (step S316).

As described above, Bc(i)=0 indicates that no finger is present above the button B(i). Accordingly, when no finger is present above any of the buttons B(1) to B(4), all four conditions in step S316 are satisfied.

In step S316, when it is determined that all of the four conditions are satisfied (step S316: YES), the processing unit 113 terminates the series of processes illustrated in FIGS. 5 and 6. In step S316, when it is determined that not all of the four conditions are satisfied (step S316: NO), the processing unit 113 performs hysteresis processing (step S317) and then terminates the series of processes illustrated in FIGS. 5 and 6. When a hand is present over a plurality of buttons, the hysteresis processing in step S317 is executed.

As illustrated in FIGS. 5 and 6, the processing unit 113 may determine the presence of a hand above a button (operation section) whose surrounding electrostatic sensor electrodes exhibit the largest capacitance value among the plurality of buttons (operation sections). With this processing, when a user's hand is present over a plurality of buttons (operation sections), the processing unit 113 can ignore buttons (operation sections) that the user does not intend to operate and identify the button (operation section) that the user intends to operate.

Note that, in the position calculation processing in the flowchart illustrated in FIGS. 5 and 6, the branching process (step S205) using the condition 3 in the flowchart of FIG. 3 is not included; however, this processing may be included.

### Example of Hysteresis Processing Procedure Performed by Processing Unit 113

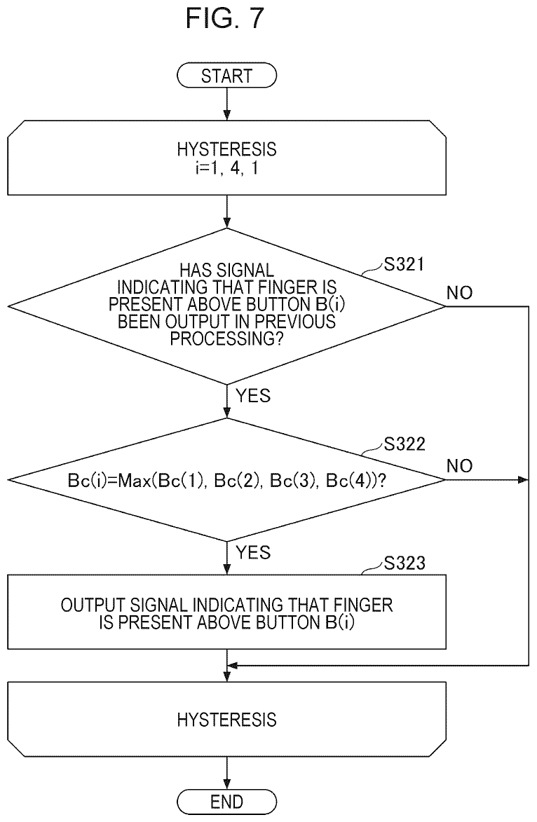

FIG. 7 is a flowchart illustrating an example of the hysteresis processing procedure to be performed by the processing unit 113 in the input device 100 according to one embodiment. FIG. 7 specifically illustrates the hysteresis processing procedure in step S 317 in FIG. 6. The processing unit 113 repeatedly executes steps S321 to S323 as the hysteresis processing. Here, the number of buttons is set to “4”, a variable i indicating a button B(i) to be processed is set such that its start value is “1”, its end value is “4”, and its increment is “1”.

First, the processing unit 113 determines whether a signal indicating that a finger is present above the button B(i) has been output in the previous processing (step S321).

In step S321, when it is determined that a signal indicating that a finger is present above the button B(i) has not been output in the previous processing (step S321: NO), the processing unit 113 terminates the hysteresis processing for the button B(i). In step S321, when it is determined that a signal indicating that a finger is present above the button B(i) has been output in the previous processing (step S321: YES), the processing unit 113 determines whether a condition Bc(i)=Max(Bc(1), Bc(2), Bc(3), Bc(4)) is satisfied (step S322).

In step S322, when it is determined that the condition Bc(i)=Max(Bc(1), Bc(2), Bc(3), Bc(4)) is not satisfied (step S322: NO), the processing unit 113 terminates the hysteresis processing for the button B(i). In step S322, when it is determined that the condition Bc(i)=Max(Bc(1), Bc(2), Bc(3), Bc(4)) is satisfied (step S322: YES), the processing unit 113 outputs a signal indicating that a finger is present above the button B(i) (step S323), and terminates the hysteresis processing for the button B(i).

After executing all hysteresis processing for the buttons B1 to B4, the processing unit 113 terminates the series of hysteresis processes in FIG. 7.

According to the series of hysteresis processes illustrated in FIG. 7, for example, when it has been determined in the previous processing that a finger is present above the button B(i), and when the Bc(1) is the largest value in this processing, it is determined that the finger is present above the button B(1), and then a signal indicating that the finger is present above the button B(i) can be output again. With this processing, when a finger moves slightly, a signal indicating that the finger is present above the button B(i) continues to be output, and thus frequent switching of the output can be prevented.

In addition, according to the series of hysteresis processes illustrated in FIG. 7, for example, when it has been determined in the previous processing that a finger is present above the button B(i), and the Bc(1) is not the largest value, if the value is not greater than the other values by 10% or more, it can be determined that no finger is present above the button B(1) (i.e., the finger has moved), and a signal indicating that the finger is present above the button B(i) may be prevented from being output again.

### Third Example of Processing Procedure Performed by Processing Unit 113

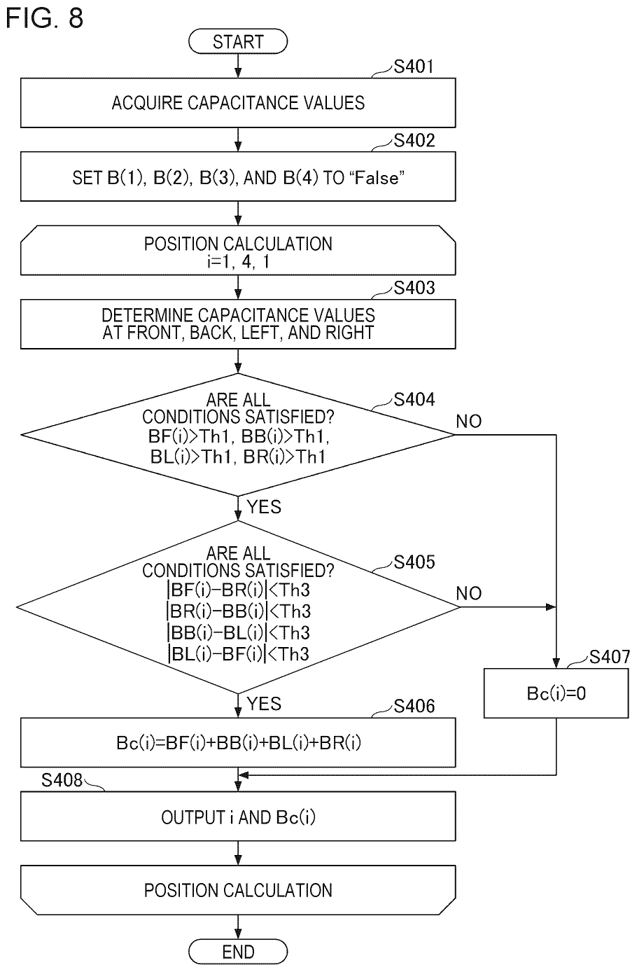

FIG. 8 is a flowchart illustrating an example (third example) processing procedure to be performed by the processing unit 113 in the input device 100 according to one embodiment.

First, the processing unit 113 acquires capacitance values of the electrostatic sensor electrodes measured by the measurement circuit 111 (step S401). Next, the processing unit 113 sets each of variables B(1), B(2), B(3), and B(4) to “False” (step S402). Next, the processing unit 113 repeatedly executes steps S403 to S408 as position calculation processing. Here, the number of buttons is set to “4”, and a variable i indicating a button B(i) to be processed is set such that its start value is “1”, its end value is “4”, and its increment is “1”.

In step S403, the processing unit 113 determines front, back, left, and right capacitance values of the button B(i) to be processed, in the same manner as in step S202 in FIG. 3 (step S403).

In step S404, the processing unit 113 determines whether a condition 1 is satisfied, that is, whether “all capacitance values (BF(i), BB(i), BL(i), BR(i)) at the front, back, left, and right of the buttons B(i) are higher than a predetermined first threshold Th1” is satisfied (step S404). In step S404, when it is determined that the condition 1 is satisfied (step S404: YES), the processing unit 113 proceeds to step S405. In step S404, when it is determined that the condition 1 is not satisfied (step S404: NO), the processing unit 113 sets the variable Bc(i) to “0” (step S407), outputs the variable i and the variable Bc(i) (step S408), and terminates the position calculation processing for the button B(i).

In step S405, the processing unit 113 determines whether a condition 3 is satisfied, that is, whether “the absolute value of the difference between the front and right capacitance values (|BF(i)−BR(i)|) of the button B(i), the absolute value of the difference between the right and back capacitance values (|BR(i)−BB(i)|) of the button B(i), the absolute value of the difference between the back and left capacitance values (|BB(i)−BL(i)|) of the button B(i), and the absolute value of the difference between the left and front capacitance values (|BL(i)−BF(i)|) of the button B(i) are all lower than a predetermined threshold Th3” is satisfied (step S405).

In step S405, when it is determined that the condition 3 is satisfied (step S405: YES), the processing unit 113 sets the variable Bc(i) to BF(i)+BB(i)+BL(i)+BR(i) (step S406), outputs the variable i and the variable Bc(i) (step S408), and then terminates the position calculation processing for the button B(i). In step S405, when it is determined that the condition 3 is not satisfied (step S405: NO), the processing unit 113 sets the variable Bc(i) to “0” (step S407), outputs the variable i and the variable Bc(i) (step S408), and then terminates the position calculation processing for the button B(i).

After executing all position calculation processing for the buttons B1 to B4, the processing unit 113 terminates the series of hysteresis processes in FIG. 8.

Note that, in the position calculation processing in the flowchart illustrated in FIG. 8, the branching process (step S204) using the condition 2 in the flowchart illustrated in FIG. 3 is not included, but this processing may be included.

The variable i output in the flowchart illustrated in FIG. 8 indicates an identification number of the button B(i).

The variable Bc(i) output in the flowchart illustrated in FIG. 8 indicates a degree of proximity between the operator's finger and the button B(i). The closer the distance between the operator's finger and the button B(i), the larger the variable Bc(i) becomes. When variable Bc(i) is zero, it indicates that no operator's finger is present in the vicinity of the button B(i).

As illustrated in FIG. 8, the processing unit 113 may output, for each of the plurality of buttons (operation sections), the degree of proximity of the operator's hand based on the capacitance values of the plurality of electrostatic sensor electrodes disposed around the button. In this case, the processing unit 113 may represent a state in which an operator's hand is not in proximity to the button (operation section) as “0”. That is, whether an operator's hand is in proximity to the button (operation member) may be represented by using the variable indicating the degree of proximity of the hand. In other words, the variable indicating whether an operator's hand is in proximity to the button (operation section) is not limited to a Boolean type.

### Fourth Example of Processing Procedure Performed by Processing Unit 113

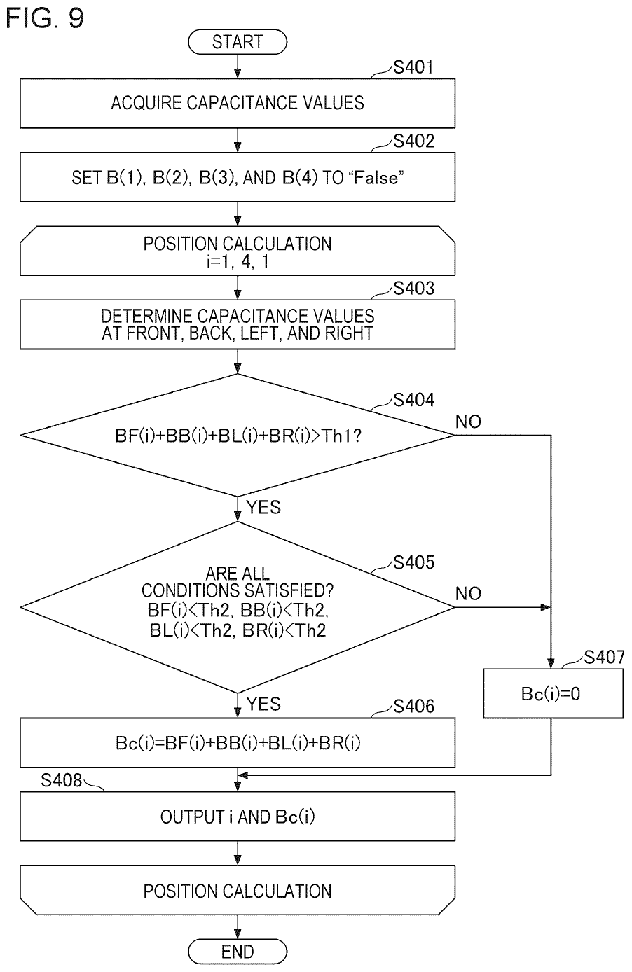

FIG. 9 is a flowchart illustrating an example (fourth example) processing procedure to be performed by the processing unit 113 in the input device 100 according to one embodiment. The flowchart illustrated in FIG. 9 is a modification of the flowchart illustrated in FIG. 8, and steps S404 to S406 differ from those in the flowchart illustrated in FIG. 8.

In step S404, the processing unit 113 determines whether a condition 4 is satisfied, that is, whether “the sum of all capacitance values (BF(i)+BB(i)+BL(i)+BR(i)) at the front, back, left, and right of the button B(i) is higher than a predetermined first threshold Th1” is satisfied (step S404). In step S404, when it is determined that the condition 4 is satisfied (step S404: YES), the processing unit 113 proceeds to step S405. In step S404, when it is determined that the condition 4 is not satisfied (step S404: NO), the processing unit 113 proceeds to step S407.

In step S405, the processing unit 113 determines whether a condition 5 is satisfied, that is, whether “all capacitance values (BF(i), BB(i), BL(i), BR(i)) at the front, back, left, and right of the button B(i) are lower than a predetermined second threshold Th2” is satisfied (step S405). In step S405, when it is determined that the condition 5 is satisfied (step S405: YES), the processing unit 113 proceeds to step S406. In step S405, when it is determined that the condition 5 is not satisfied (step S405: NO), the processing unit 113 proceeds to step S407.

### Fifth Example of Processing Procedure Performed by Processing Unit 113

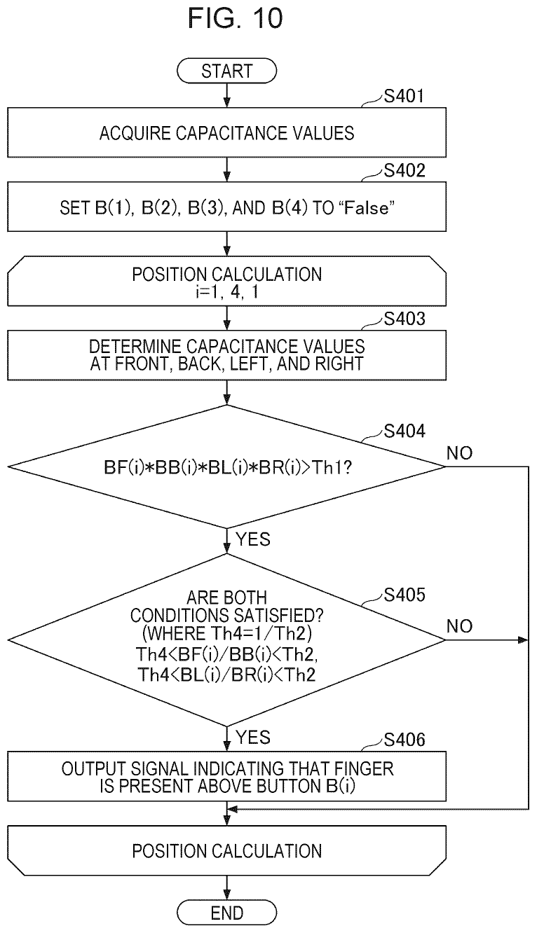

FIG. 10 is a flowchart illustrating an example (fifth example) processing procedure to be performed by the processing unit 113 in the input device 100 according to one embodiment. The flowchart illustrated in FIG. 10 is a modification of the flowchart illustrated in FIG. 8, and differs from the flowchart illustrated in FIG. 8 in that steps S404 to S408 are changed to step S404 to S406 described below.

In step S404, the processing unit 113 determines whether a condition 6 is satisfied, that is, whether “the product of all capacitance values (BF(i)*BB(i)*BL(i)*BR(i)) at the front, back, left, and right of the button B(i) is higher than a predetermined first threshold Th1” is satisfied (step S404). In step S404, when it is determined that the condition 6 is satisfied (step S404: YES), the processing unit 113 proceeds to step S405. In step S404, when it is determined that the condition 6 is not satisfied (step S404: NO), the processing unit 113 terminates the position calculation processing for the button B(i).

In step S405, the processing unit 113 determines whether a condition 7 is satisfied, that is, whether both “Th4<BF(i)/BB(i)<Th2” and “Th4<BL(i)/BR(i)<Th2” (where Th4=1/Th2) are satisfied (step S405). In step S405, when it is determined that the condition 7 is satisfied (step S405: YES), the processing unit 113 outputs a signal indicating that the finger is present above the button B(i) (step S406), and terminates the position calculation processing for the button B(i). In step S405, when it is determined that the condition 7 is not satisfied (step S405: NO), the processing unit 113 terminates the position calculation processing for the button B(i).

### Second to Fourth Examples of Arrangement of Buttons and Electrostatic Sensor Electrodes

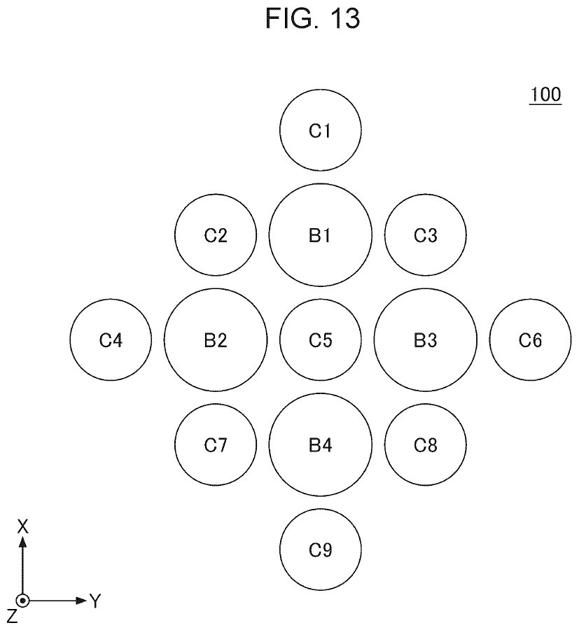

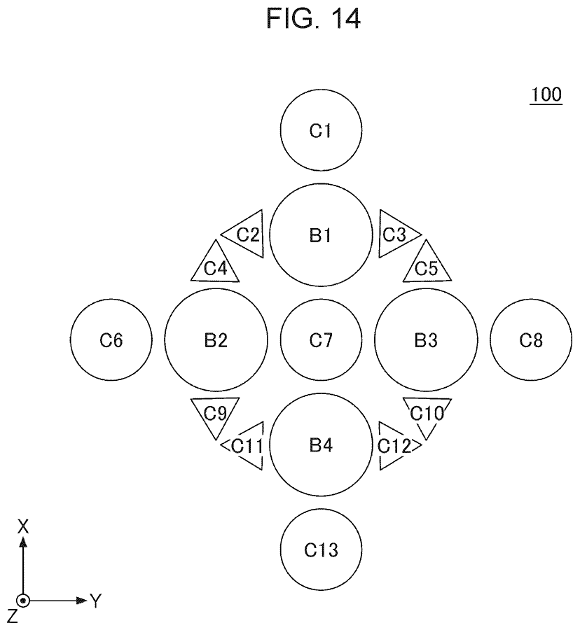

FIG. 11 is a diagram illustrating an example (second example) arrangement of buttons and electrostatic sensor electrodes in the input device 100 according to one embodiment. FIG. 12 is a diagram illustrating an example (third example) arrangement of buttons and electrostatic sensor electrodes in the input device 100 according to one embodiment. FIG. 13 is a diagram illustrating an example (fourth example) arrangement of buttons and electrostatic sensor electrodes in the input device 100 according to one embodiment.

In the examples illustrated in FIGS. 11 to 13, the input device 100 includes four buttons B1 to B4 similar to those in FIG. 1 and nine electrostatic sensor electrodes C1, C2, C3, C4, C5, C6, C7, C8, and C9. The electrostatic sensor electrodes C1 to C9 illustrated in FIGS. 11 to 13 are used by the measurement circuit 111 for self-capacitance-based capacitance detection.

In the example illustrated in FIG. 11, each of the electrostatic sensor electrodes C1 to C9 has a square shape. In the example illustrated in FIG. 12, each of the electrostatic sensor electrodes C1 to C9 has an octagonal shape. In the example illustrated in FIG. 13, each of the electrostatic sensor electrodes C1 to C9 has a circular shape.

In particular, in the examples illustrated in FIGS. 12 and 13, each of the electrostatic sensor electrodes C1 to C9 has a shape that becomes narrower in width toward a button (operation section). Accordingly, capacitive coupling between a button (operation section) and an electrostatic sensor electrode can be reduced even if the electrostatic sensor electrode is disposed in close proximity to the button (operation section), and thus the detection accuracy of the electrostatic sensor electrodes can be increased.

In other words, each of the electrostatic sensor electrodes C1 to C9 illustrated in FIGS. 12 and 13 has a chamfered shape having four chamfered corners in contrast to the square electrostatic sensor electrodes C1 to C9 illustrated in FIG. 11. Accordingly, each of the electrostatic sensor electrodes C1 to C9 illustrated in FIGS. 12 and 13 can, for example, reduce capacitive coupling with an operator's hand that is present in an area outside the buttons.

In the examples illustrated in FIGS. 11 to 13, for each of the four buttons B1 to B4, four electrostatic sensor electrodes of the same shape and the same size are disposed symmetrically in the front-back direction and the left-right direction. The electrostatic sensor electrode disposed between two adjacent buttons is a common electrostatic sensor electrode.

Specifically, on the front side (positive X-axis side), back side (negative X-axis side), left side (negative Y-axis side), and right side (positive Y-axis side) of the button B1, the electrostatic sensor electrodes C1, C5, C2, and C3 are disposed respectively. In the flowcharts illustrated in FIG. 3 and FIGS. 5 to 8, the capacitance values of the electrostatic sensor electrodes C1, C5, C2, and C3 may be used as B(1)F, B(1)B, B(1)L, and B(1)R, respectively.

On the front side (positive X-axis side), back side (negative X-axis side), left side (negative Y-axis side), and right side (positive Y-axis side) of the button B2, the electrostatic sensor electrodes C2, C7, C4, and C5 are disposed respectively. In the flowcharts illustrated in FIG. 3 and FIGS. 5 to 8, the capacitance values of the electrostatic sensor electrodes C2, C7, C4, and C5 may be used as B(2)F, B(2)B, B(2)L, and B(2)R, respectively.

On the front side (positive X-axis side), back side (negative X-axis side), left side (negative Y-axis side), and right side (positive Y-axis side) of the button B3, the electrostatic sensor electrodes C3, C8, C5, and C6 are disposed respectively. In the flowcharts illustrated in FIG. 3 and FIGS. 5 to 8, the capacitance values of the electrostatic sensor electrodes C3, C8, C5, and C6 may be used as B(3)F, B(3)B, B(3)L, and B(3)R, respectively.

On the front side (positive X-axis side), back side (negative X-axis side), left side (negative Y-axis side), and right side (positive Y-axis side) of the button B4, the electrostatic sensor electrodes C5, C9, C7, and C8 are disposed respectively. In the flowcharts illustrated in FIG. 3 and FIGS. 5 to 8, the capacitance values of the electrostatic sensor electrodes C5, C9, C7, and C8 may be used as B(4)F, B(4)B, B(4)L, and B(4)R, respectively.

In the configurations illustrated in FIGS. 11 to 13, with respect to each of the four buttons (operation sections), four electrostatic sensor electrodes are arranged to form a cross shape when viewed from above (in the positive Z-axis direction). One of the electrostatic sensor electrodes (for example, C5) disposed at a position surrounded by the four buttons (operation sections) is commonly used by the four buttons (operation sections), and also shared by the four buttons (operation sections) to form such a cross shape of the electrostatic sensor electrodes around each button.

With these configurations, the number of electrostatic sensor electrodes in the area surrounded by the four buttons (operation sections) can be reduced, thereby enabling the input device 100 to be made more compact in size.

### Fifth Example of Arrangement of Buttons and Electrostatic Sensor Electrodes

FIG. 14 is a diagram illustrating an example (fifth example) arrangement of buttons and electrostatic sensor electrodes in the input device 100 according to one embodiment.

In the examples illustrated in FIG. 14, the input device 100 includes four buttons B1 to B4 similar to those in FIG. 1 and thirteen electrostatic sensor electrodes C1, C2, C3, C4, C5, C6, C7, C8, C9, C10, C11, C12, and C13. The electrostatic sensor electrodes C1 to C13 illustrated in FIG. 14 are used by the measurement circuit 111 for self-capacitance-based capacitance detection.

In the example illustrated in FIG. 14, for each of the four buttons B1 to B4, two electrostatic sensor electrodes having left-right symmetry and two electrostatic sensor electrodes having front-back symmetry are provided. In particular, the two left-right electrodes and the two front-back electrodes differ in shape and size.

In the example illustrated in FIG. 14, compared with the example illustrated in FIG. 13, in the input device 100, some of the electrostatic sensor electrodes are reduced in size and changed to have a triangular shape.

More specifically, for the button B1 disposed at the front side, two circular electrostatic sensor electrodes C1 and C7 are disposed in front-back symmetry, and two small triangular electrostatic sensor electrodes C2 and C3 are disposed in left-right symmetry.

For the button B4 disposed at the back side, two circular electrostatic sensor electrodes C7 and C13 are disposed in front-back symmetry, and two small triangular electrostatic sensor electrodes C11 and C12 are disposed in left-right symmetry.

For the button B2 disposed at the left side, two circular electrostatic sensor electrodes C6 and C7 are disposed in left-right symmetry, and two small triangular electrostatic sensor electrodes C4 and C9 are arranged in front-back symmetry.

For the button B3 disposed at the right side, two circular electrostatic sensor electrodes C7 and C8 are disposed in left-right symmetry, and two small triangular electrostatic sensor electrodes C5 and C10 are disposed in front-back symmetry.

In the example illustrated in FIG. 14, compared with the example illustrated in FIG. 13, some of the electrostatic sensor electrodes are reduced in size and changed to have the triangular shape. Accordingly, the installation space required for the plurality of electrostatic sensor electrodes can be reduced.

As in the example illustrated in FIG. 14, for each button, a plurality of electrostatic sensor electrodes having different shapes may be disposed. However, it is preferable that, as in the example illustrated in FIG. 14, the two electrostatic sensor electrodes that face each other across a button have the same shape (symmetrical shape).

As in the example illustrated in FIG. 14, when two adjacent electrostatic sensor electrodes have different shapes, in the flowcharts illustrated in FIG. 3 and other drawings, it is preferable to perform the determination processing that uses the difference between the capacitance values of two electrostatic sensor electrodes disposed to face each other (i.e., the processing of determining whether the condition 2 is satisfied), and not to perform the determination processing that uses the difference between the capacitance values of two electrostatic sensor electrodes disposed adjacent to each other (i.e., the processing of determining whether the condition 3 is satisfied).

In the configuration illustrated in FIG. 14, with respect to each of the four buttons (operation sections), the four electrostatic sensor electrodes disposed in a cross shape, and one electrostatic sensor electrode disposed at a position surrounded by the four buttons (operation sections) is commonly shared among the four buttons (operation sections). With this configuration, the number of electrostatic sensor electrodes in the area surrounded by the four buttons (operation sections) can be reduced, thereby enabling the input device 100 to be made more compact in size.

### Sixth and Seventh Examples of Arrangement of Buttons and Electrostatic Sensor Electrodes

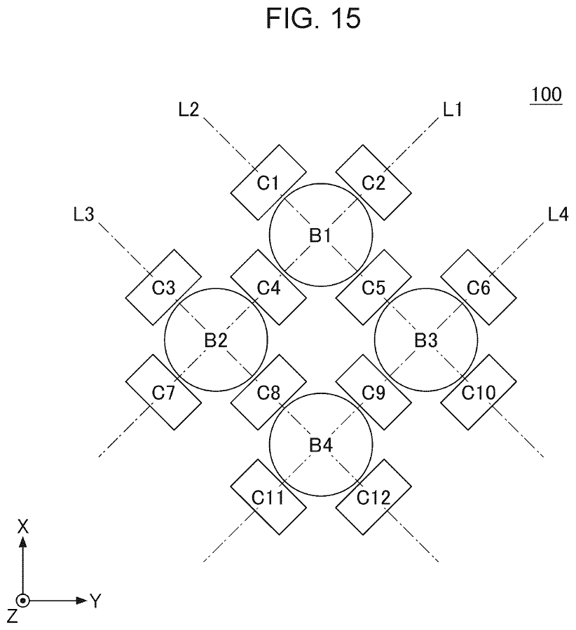

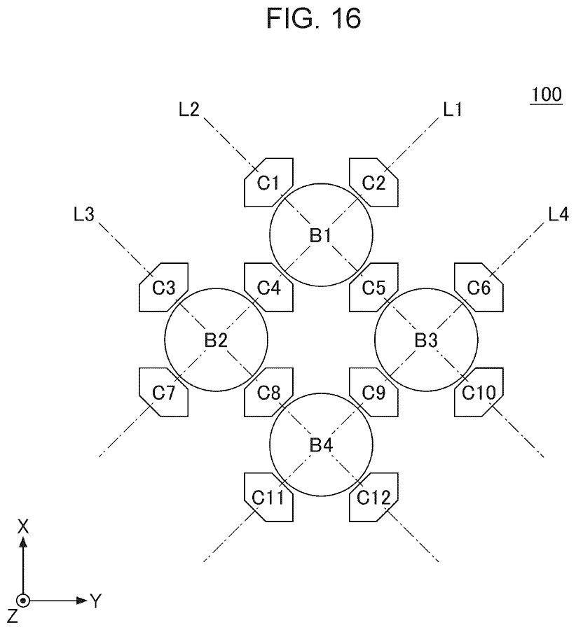

FIG. 15 is a diagram illustrating an example (sixth example) arrangement of buttons and electrostatic sensor electrodes in the input device 100 according to one embodiment. FIG. 16 is a diagram illustrating an example (seventh example) arrangement of buttons and electrostatic sensor electrodes in the input device 100 according to one embodiment.

In the examples illustrated in FIGS. 15 and 16, the input device 100 includes four buttons B1 to B4 similar to those in FIG. 1 and twelve electrostatic sensor electrodes C1, C2, C3, C4, C5, C6, C7, C8, C9, C10, C11, and C12. The electrostatic sensor electrodes C1 to C12 illustrated in FIGS. 15 and 16 are used by the measurement circuit 111 for self-capacitance-based capacitance detection.

In the example illustrated in FIG. 15, each of the electrostatic sensor electrodes C1 to C12 has a rectangular shape. In the example illustrated in FIG. 16, each of the electrostatic sensor electrodes C1 to C12 has a hexagonal shape.

In particular, in the example illustrated in FIG. 16, each of the electrostatic sensor electrodes C1 to C12 has a shape that becomes narrower in width toward a button (operation section). With this shape, capacitive coupling between a button (operation section) and an electrostatic sensor electrode can be reduced even if the electrostatic sensor electrode is disposed in close proximity to the button (operation section), and thus the detection accuracy of the electrostatic sensor electrodes can be increased.

In the examples illustrated in FIGS. 15 and 16, for each of the four buttons B1 to B4, four electrostatic sensor electrodes of the same shape and the same size are disposed in a cross shape. Each of the electrostatic sensor electrodes is disposed on a straight line passing through the centers of two adjacent buttons, that is, the electrostatic sensor electrodes are disposed in diagonal directions (front right, front left, back right, and back left) respectively. The electrostatic sensor electrode disposed between two adjacent buttons is a common electrostatic sensor electrode.

More specifically, on the diagonal line L1 passing through the centers of the buttons B1 and B2, the electrostatic sensor electrode C2, the button B1, the electrostatic sensor electrode C4, the button B2, and the electrostatic sensor electrode C7 are disposed in this order from the front right toward the back left.

On the diagonal line L2 passing through the centers of buttons B1 and B3, the electrostatic sensor electrode C1, the button B1, the electrostatic sensor electrode C5, the button B3, and the electrostatic sensor electrode C10 are disposed in this order from the front left toward the back right.

On the diagonal line L3 passing through the centers of buttons B2 and B4, the electrostatic sensor electrode C3, the button B2, the electrostatic sensor electrode C8, the button B4, and the electrostatic sensor electrode C12 are disposed in this order from the front left toward the back right.

On the diagonal line LA passing through the centers of buttons B3 and B4, the electrostatic sensor electrode C6, the button B3, the electrostatic sensor electrode C9, the button B4, and the electrostatic sensor electrode C11 are disposed in this order from the front right toward the back left.

Also in the input device 100 illustrated in FIGS. 15 and 16, in the flowcharts illustrated in FIG. 3 and FIGS. 5 to 8, the capacitance values of the four electrostatic sensor electrodes disposed around each button B(i) may be used as BF(i), BB(i), BL(i), and BR(i).

In both FIGS. 15 and 16, each of the electrostatic sensor electrodes C1 to C12 has a longitudinal shape such that a direction along a straight line connecting two adjacent buttons corresponds to a short-side direction, and a direction orthogonal to the direction along the straight line connecting the two adjacent buttons corresponds to a long-side direction. With this configuration, in the example illustrated in FIGS. 15 and 16, the distance between two adjacent buttons can be reduced.

In addition, in both FIGS. 15 and 16, each of the electrostatic sensor electrodes C1 to C12 has a shape such that the side facing the corresponding button is bisected perpendicularly by the straight line (one of the diagonal lines L1 to L4) passing through the electrostatic sensor electrode.

In the configuration illustrated in FIGS. 15 and 16, the electrostatic sensor electrodes are provided only on the first diagonal line L1 passing through the centers of a first operation section (button B1) and a second operation section (button B2) disposed adjacent to each other in the diagonal direction, the second diagonal line L2 passing through the centers of the first operation section (button B1) and a third operation section (button B3) disposed adjacent to each other in the diagonal direction, the third diagonal line L3 passing through the centers of the second operation section (button B2) and a fourth operation section (button B4) disposed adjacent to each other in the diagonal direction, and the fourth diagonal line L4 passing through the centers of the third operation section (button B3) and a fourth operation section (button B4) disposed adjacent to each other in the diagonal direction. This configuration enables the input device 100 to be made more compact in the front-back direction and the left-right direction.

In addition, in the configuration illustrated in FIGS. 15 and 16, the width of each of the plurality of electrostatic sensor electrodes C1 to C12 in the direction parallel to the diagonal line passing through the electrostatic sensor electrode is less than the width in the direction orthogonal to the diagonal line passing through the electrostatic sensor electrode. This configuration enables the input device 100 to be made more compact in the directions in which the respective diagonal lines extend.

### Eighth Example of Arrangement of Buttons and Electrostatic Sensor Electrodes

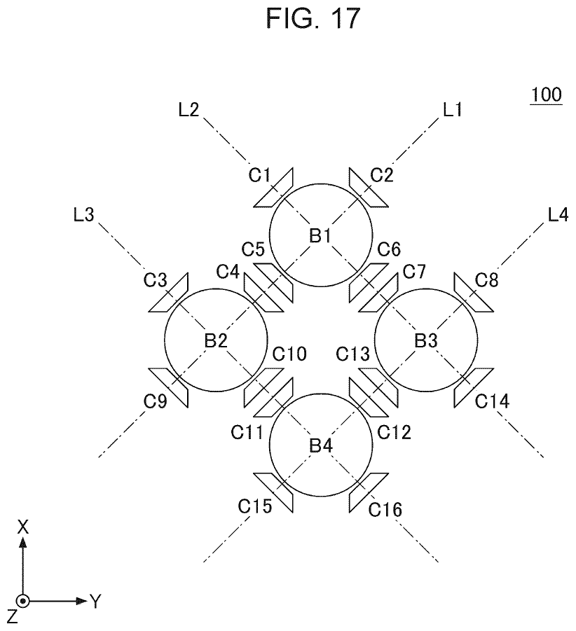

FIG. 17 is a diagram illustrating an example (eighth example) arrangement of buttons and electrostatic sensor electrodes in the input device 100 according to one embodiment. In the example illustrated in FIG. 17, the input device 100 includes four buttons B1 to B4 similar to those in FIG. 1 and sixteen electrostatic sensor electrodes C1, C2, C3, C4, C5, C6, C7, C8, C9, C10, C11, C12, C13, C14, C15, and C16. The electrostatic sensor electrodes C1 to C16 illustrated in FIG. 17 are used for self-capacitance-based capacitance detection by the measurement circuit 111.

In the example illustrated in FIG. 17, for each of the four buttons B1 to B4, four electrostatic sensor electrodes of the same shape and the same size are disposed in a cross shape. Each of the electrostatic sensor electrodes is disposed on a straight line (on one of the diagonal lines L1 to L4) passing through the centers of two adjacent buttons, that is, the electrostatic sensor electrodes are disposed in diagonal directions (front right, front left, back right, and back left) respectively. In contrast to the examples shown in FIGS. 15 and 16, in the example illustrated in FIG. 17, two separate electrostatic sensor electrodes are disposed for the respective buttons instead of the single common electrostatic sensor electrode between two adjacent buttons.

Specifically, the electrostatic sensor electrodes C2, C5, C1, and C6 are disposed at the front right, back left, front left, and back right of the button B1, respectively. In the flowcharts illustrated in FIG. 3 and FIGS. 5 to 8, the capacitance values of the electrostatic sensor electrodes C2, C5, C1, and C6 may be used as B(1)F, B(1)B, B(1)L, and B(1)R, respectively.

The electrostatic sensor electrodes C4, C9, C3, and C10 are disposed at the front right, back left, front left, and back right of the button B2, respectively. In the flowcharts illustrated in FIG. 3 and FIGS. 5 to 8, the capacitance values of the electrostatic sensor electrodes C4, C9, C3, and C10 may be used as B(2)F, B(2)B, B(2)L, and B(2)R, respectively.

The electrostatic sensor electrodes C8, C13, C7, and C14 are disposed at the front right, back left, front left, and back right of the button B3, respectively. In the flowcharts illustrated in FIG. 3 and FIGS. 5 to 8, the capacitance values of the electrostatic sensor electrodes C8, C13, C7, and C14 may be used as B(3)F, B(3)B, B(3)L, and B(3)R, respectively.

The electrostatic sensor electrodes C12, C15, C11, and C16 are disposed at the front right, back left, front left, and back right of the button B4, respectively. In the flowcharts illustrated in FIG. 3 and FIGS. 5 to 8, the capacitance values of the electrostatic sensor electrodes C12, C15, C11, and C16 may be used as B(4)F, B(4)B, B(4)L, and B(4)R, respectively.

In the example illustrated in FIG. 17, each of the electrostatic sensor electrodes C1 to C16 has a trapezoidal shape in which the upper base faces the corresponding button. That is, in FIG. 17, each of the electrostatic sensor electrodes C1 to C16 has a trapezoidal shape such that a direction along a straight line connecting two adjacent buttons corresponds to a short-side direction, and a direction orthogonal to the direction along the straight line connecting the two adjacent buttons corresponds to a long-side direction. With this configuration, in the example illustrated in FIG. 17, the distance between two adjacent buttons can be further reduced.

In particular, in the example illustrated in FIG. 17, each of the electrostatic sensor electrodes C1 to C16 has a shape that becomes narrower in width toward a button (operation section). With this shape, capacitive coupling between a button (operation section) and an electrostatic sensor electrode can be reduced even if the electrostatic sensor electrode is disposed in close proximity to the button (operation section), and thus the detection accuracy of the electrostatic sensor electrodes can be increased.

In addition, in FIG. 17, each of the electrostatic sensor electrodes C1 to C16 has a shape such that the side facing the corresponding button is bisected perpendicularly by the straight line (one of the diagonal lines L1 to L4) passing through the electrostatic sensor electrode.

In the example illustrated in FIG. 17, each of the electrostatic sensor electrodes C1 to C16 has the trapezoidal shape (i.e., a halved shape of the hexagonal electrostatic sensor electrode illustrated in FIG. 16), and thus the installation space for each of the electrostatic sensor electrodes C1 to C16 can be reduced.

### Ninth Example of Arrangement of Buttons and Electrostatic Sensor Electrodes

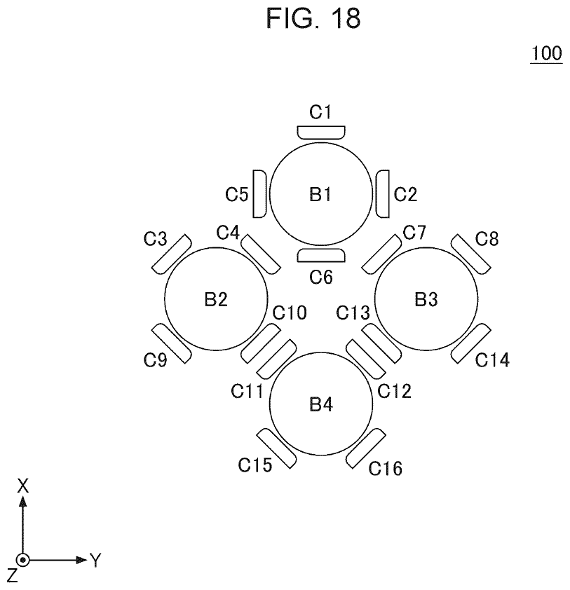

FIG. 18 is a diagram illustrating an example (ninth example) arrangement of buttons and electrostatic sensor electrodes in the input device 100 according to one embodiment. In the example illustrated in FIG. 18, the input device 100 includes, similar to the configuration illustrated in FIG. 17, four buttons B1 to B4 and sixteen electrostatic sensor electrodes C1, C2, C3, C4, C5, C6, C7, C8, C9, C10, C11, C12, C13, C14, C15, and C16. The electrostatic sensor electrodes C1 to C16 illustrated in FIG. 18 are used for self-capacitance-based capacitance detection by the measurement circuit 111.

In the example illustrated in FIG. 18, as in the configuration illustrated in FIG. 17, for each of the four buttons B1 to B4, four electrostatic sensor electrodes of the same shape and the same size are disposed in a cross shape.

In the example illustrated in FIG. 18, however, for the button B1, four electrostatic sensor electrodes are disposed in the front, back, left, and right directions, whereas for each of the buttons B2 to B4, four electrostatic sensor electrodes are arranged in diagonal directions (front right, front left, back right, and back left).

Each of the electrostatic sensor electrodes C1 to C16 illustrated in FIG. 18 has a rectangular shape in which a side facing the corresponding button (operation section) is a long side, and in addition, has a shape in which two corners facing the corresponding button (operation section) are chamfered into curved portions.

As illustrated in FIG. 18, the orientation of the four electrostatic sensor electrodes may differ between the four buttons. The orientation of the four electrostatic sensor electrodes with respect to each corresponding button may be determined in consideration of ease of arrangement of the four electrostatic sensor electrodes around each button and other factors.

### Tenth Example of Arrangement of Buttons and Electrostatic Sensor Electrodes

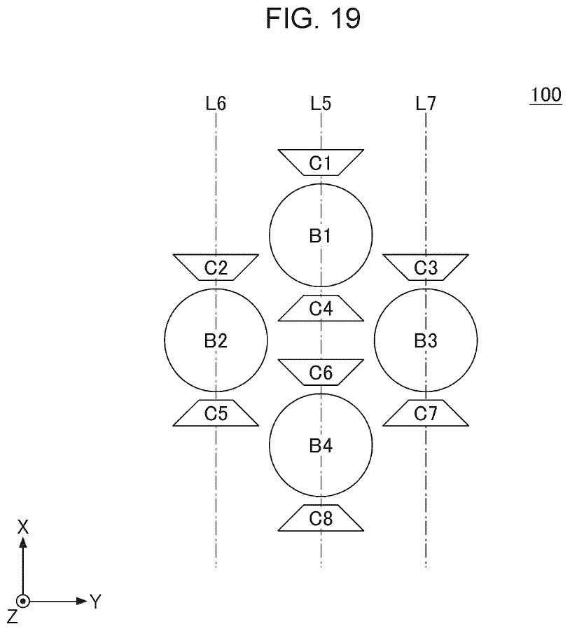

FIG. 19 is a diagram illustrating an example (tenth example) arrangement of buttons and electrostatic sensor electrodes in the input device 100 according to one embodiment. In the example illustrated in FIG. 19, the input device 100 includes four buttons B1 to B4 similar to those in FIG. 1 and eight electrostatic sensor electrodes C1, C2, C3, C4, C5, C6, C7, and C8. The electrostatic sensor electrodes C1 to C8 illustrated in FIG. 19 are used for self-capacitance-based capacitance detection by the measurement circuit 111.

In the example illustrated in FIG. 19, for each of the four buttons B1 to B4, two electrostatic sensor electrodes of the same shape and the same size are disposed in the front-back direction. Accordingly, in the example illustrated in FIG. 19, for each of the four buttons B1 to B4, the processing unit 113 detects whether an operator's hand is present above the button based on the capacitance values of the two electrostatic sensor electrodes disposed in the front-back direction.

As in this example, the number of electrostatic sensor electrodes disposed for each button is not limited to four, and may be two.

In the example illustrated in FIG. 19, each of the electrostatic sensor electrodes C1 to C8 has a trapezoidal shape in which the upper base faces the corresponding button; however, other shapes such as a quadrilateral, circular, hexagonal, or triangular shape may also be employed.

In the configuration illustrated in FIG. 19, the electrostatic sensor electrodes are provided only on a first straight line L5 passing through the centers of a first operation section (button B1), a second operation section (button B4), a second straight line L6 parallel to the first straight line L5 and passing through the center of a third operation section (button B2), and a third straight line L7 parallel to the first straight line L5 and passing through the center of a fourth operation section (button B3). With this configuration, the size in the direction (left-right direction) orthogonal to each of the straight lines L5 to L7 can be reduced.

### Eleventh Example of Arrangement of Buttons and Electrostatic Sensor Electrodes

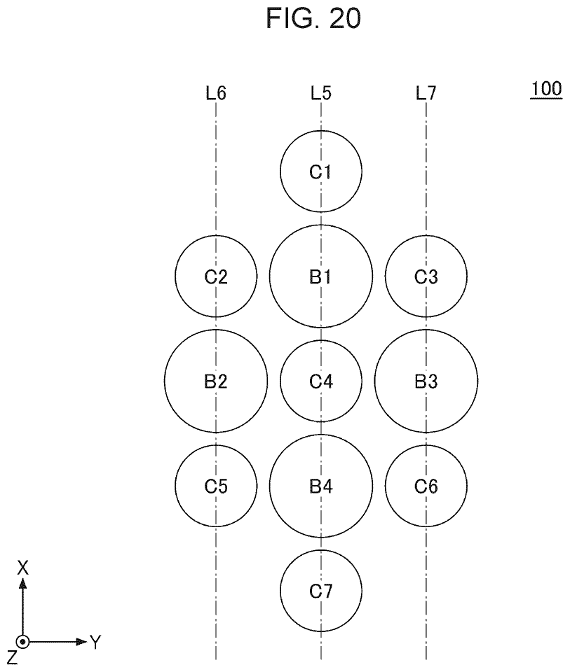

FIG. 20 is a diagram illustrating an example (eleventh example) arrangement of buttons and electrostatic sensor electrodes in the input device 100 according to one embodiment. In the example illustrated in FIG. 20, the input device 100 includes four buttons B1 to B4 similar to those in FIG. 1 and seven electrostatic sensor electrodes C1, C2, C3, C4, C5, C6, and C7. The electrostatic sensor electrodes C1 to C7 illustrated in FIG. 20 are used for self-capacitance-based capacitance detection by the measurement circuit 111.

In the example illustrated in FIG. 20, for each of the two buttons B1 and B4, four electrostatic sensor electrodes of the same shape and the same size are disposed in the front, back, left, and right directions, whereas for each of the two buttons B2 and B3, three electrostatic sensor electrodes of the same shape and the same size are disposed in the front-back direction and in the right direction or the left direction. In the example illustrated in FIG. 20, at a central position surrounded by the four buttons B1 to B4, the electrostatic sensor electrode C4 commonly shared among the four buttons B1 to B4 is disposed.

Accordingly, in the example illustrated in FIG. 20, for each of the two buttons B1 and B4, the processing unit 113 detects whether an operator's hand is present above the button based on the capacitance values of the four electrostatic sensor electrodes disposed in the front, back, left, and right directions, whereas for each of the two buttons B2 and B3, the processing unit 113 detects whether an operator's hand is present above the button based on the capacitance values of the three electrostatic sensor electrodes disposed in the front-back direction and in the right direction or the left direction.

As in this example, the number of electrostatic sensor electrodes disposed for each button is not limited to four, and may be two or three.

In the example illustrated in FIG. 20, each of the electrostatic sensor electrodes C1 to C7 has a circular shape; however, other shapes such as a quadrilateral, trapezoidal, hexagonal, or triangular shape may also be employed.

In the configuration illustrated in FIG. 20, the electrostatic sensor electrodes are provided only on a first straight line L5 passing through the centers of a first operation section (button B1) and a second operation section (button B4), a second straight line L6 parallel to the first straight line L5 and passing through the center of a third operation section (button B2), and a third straight line L7 parallel to the first straight line L5 and passing through the center of a fourth operation section (button B3). With this configuration, the size in the direction (left-right direction) orthogonal to each straight line can be reduced.

In particular, in the configuration illustrated in FIG. 20, each of the electrostatic sensor electrodes C1 to C7 has a circular shape, and accordingly, even when an operator's hand shifts from a button in a direction (left-right direction) orthogonal to the straight lines, the hand can be detected with high accuracy by the electrostatic sensor electrodes disposed to face each other on the straight lines.

### Twelfth Example of Arrangement of Buttons and Electrostatic Sensor Electrodes

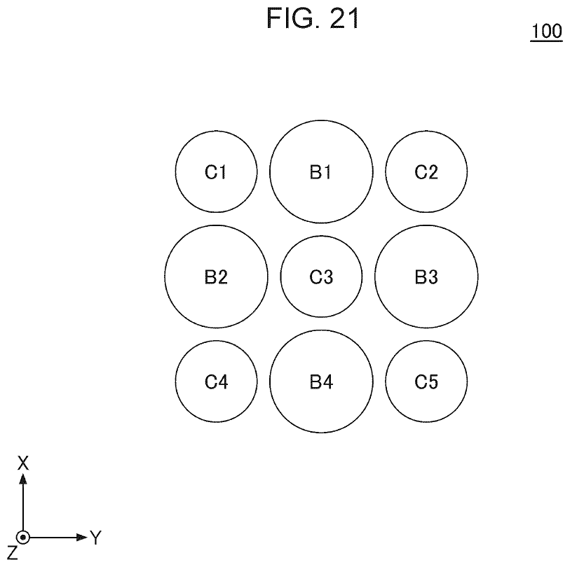

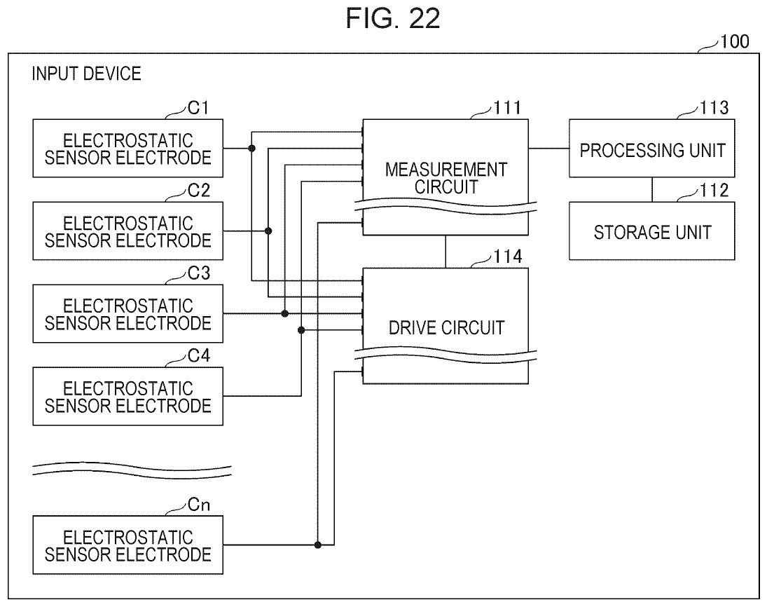

FIG. 21 is a diagram illustrating an example (twelfth example) arrangement of buttons and electrostatic sensor electrodes in the input device 100 according to one embodiment. In the example illustrated in FIG. 21, the input device 100 includes four buttons B1 to B4 similar to those in FIG. 1 and five electrostatic sensor electrodes C1, C2, C3, C4, and C5. The electrostatic sensor electrodes C1 to C5 illustrated in FIG. 21 are used for self-capacitance-based capacitance detection by the measurement circuit 111.

Specifically, in the example illustrated in FIG. 21, the input device 100 includes one electrostatic sensor electrode C3 disposed at a position surrounded by the four buttons B1 to B4, and four electrostatic sensor electrodes C1, C2, C4, and C5 disposed at four positions (four corners of an imaginary quadrilateral passing through the centers of the respective four buttons B1 to B4) such that each of the four buttons B1 to B4 is sandwiched by two electrostatic sensor electrodes in the front-back direction or left-right direction.

In other words, in the example illustrated in FIG. 21, three electrostatic sensor electrodes are disposed around each of the buttons B1 to B4.

Accordingly, in the example illustrated in FIG. 21, for each of the four buttons B1 to B4, the processing unit 113 detects the presence of an operator's hand above the button based on the capacitance values of the three electrostatic sensor electrodes.

In the example illustrated in FIG. 21, each of the electrostatic sensor electrodes C1 to C8 has a circular shape; however, other shapes such as a quadrilateral, trapezoidal, hexagonal, or triangular shape may also be employed.

In the configuration illustrated in FIG. 21, no electrostatic sensor electrodes are disposed outside the imaginary quadrilateral that circumscribes the four buttons B1 to B4.

Accordingly, the size of the input device 100 in plan view from above can be minimized.

### Another Example Configuration of Control System in Input Device 100

FIG. 22 is a diagram illustrating another example configuration of the control system in the input device 100 according to one embodiment. FIG. 22 is a diagram illustrating a configuration of the control system in the input device 100 that uses electrostatic sensors of the self-capacitance type (FIG. 11 to FIG. 21). As illustrated in FIG. 22, the control system in the input device 100 includes the measurement circuit 111, the drive circuit 114, the storage unit 112, and the processing unit 113. Note that the number of electrostatic sensor electrodes differs depending on the embodiment. Accordingly, FIG. 22 illustrates Cn sensor electrodes.

The drive circuit 114 and the measurement circuit 111 are electrically connected to each of the electrostatic sensor electrodes C1 to Cn. The measurement circuit 111 drives each of the electrostatic sensor electrodes C1 to Cn by supplying a drive current to each of the electrostatic sensor electrodes C1 to Cn, and detects the electrostatic capacitance between a finger and each of the electrostatic sensor electrodes C1 to Cn in the self-capacitance detection method. The closer the distance between an electrostatic sensor electrode and a hand of an operator, the greater the capacitive coupling between the electrostatic sensor electrode and the hand of the operator. Accordingly, the capacitance value detected for each of the electrostatic sensor electrodes by the measurement circuit 111 increases as the distance between the electrostatic sensor electrode and the hand of the operator decreases. The drive circuit 114 sequentially drives the electrostatic sensor electrodes C1 to Cn, and the measurement circuit 111 performs measurements on the electrostatic sensor electrodes C1 to Cn that are being driven.

The storage unit 112 stores various types of information. For example, the storage unit 112 stores a reference value that is a capacitance value when it is determined that there is no object around each of the electrostatic sensor electrodes C1 to Cn. The storage unit 112 may be a random access memory (RAM).

The processing unit 113 executes various computation processes. For example, the processing unit 113 executes processing to detect the presence of an operator's hand above the buttons B1 to B4 based on the capacitance values of the respective electrostatic sensor electrodes detected by the measurement circuit 111. The processing unit 113 may be, for example, a central processing unit (CPU), an integrated circuit (IC), or the like.

While the embodiments of the present invention have been described in detail, it is to be understood that the invention is not limited to these embodiments, various modifications or changes may be made within the scope of the invention described in the claims.

In the above-described embodiments, the “push button” is used as an example of the “operation section”; however, the present invention is not limited thereto, and for example, a “joystick” or the like may be used as the “operation section”.

In addition, in the above-described embodiments, as an example of the “operation section”, the operation section having a circular shape in plan view from above is used; however, the present invention is not limited thereto, and for example, an operation section having other shapes in plan view from above such as a quadrilateral shape, a hexagonal shape, an octagonal shape, or the like may also be employed.

1. An input device comprising:
at least one operation section operable by a hand of an operator;
a plurality of electrostatic sensor electrodes disposed around the operation section;
a measurement circuit configured to measure a capacitance for each of the plurality of electrostatic sensor electrodes, so as to obtain a plurality of capacitance values for the operation section; and
a processing unit configured to perform a detection of, the presence of the hand above the operation section by detecting that each capacitance value has changed by approximately a same amount from a reference value that is a capacitance value when the hand is not present.

2. The input device according to claim 1,
wherein the processing unit is further configured to determine based on the plurality of capacitance values, the presence of the hand in a lower space which is a vicinity of the operation section including a space above the operation section; and
wherein the processing unit performs the detection when the processing unit has determined that the hand is present in the lower space based on the plurality of capacitance values.

3. The input device according to claim 2, wherein the processing unit determines that the hand is present in the lower space:
when the plurality of capacitance values are greater than a first threshold;
when a sum of the plurality of capacitance values is greater than a first threshold; or
when a product of the plurality of capacitance values is greater than a first threshold.

4. The input device according to claim 2, wherein when a difference between two capacitance values among the plurality of capacitance values is less than a second threshold, the processing unit determines that the hand is present above the operation section.

5-6. (canceled)

7. The input device according to claim 2, wherein when the plurality of capacitance values are less than a second threshold, the processing unit determines that the hand is present above the operation section.

8. The input device according to claim 4,
wherein the plurality of electrostatic sensor electrodes includes a pair of opposite electrostatic sensor electrodes which have a seme shape and are disposed opposite to each other across the operation section,
and wherein the processing unit determines that the hand is present above the operation section when a difference between the capacitance values of the pair of opposite electrostatic sensor electrodes is less than the second threshold.

9. The input device according to claim 4,
wherein the plurality of electrostatic sensor electrodes include:
four electrostatic sensor electrodes which have a same shape and are disposed adjacent to each other at 90-degree intervals around the operation section,
and wherein the processing unit determines that the hand is present above the operation section when a difference between the capacitance values of two adjacent electrostatic sensor electrodes among the four electrostatic sensor electrodes is smaller than a third threshold.

10. The input device according to claim 4,
wherein the plurality of electrostatic sensor electrodes include:
four electrostatic sensor electrodes which has a same shape and are disposed adjacent to each other at 90-degree intervals around the operation section,
and wherein the processing unit determines that the hand is present above the operation section when a difference between the capacitance values of two opposite electrostatic sensor electrodes among the four electrostatic sensor electrode which are disposed opposite to each other across the operation section is smaller than the second threshold, and a difference between the capacitance values of two adjacent electrostatic sensor electrodes among the four electrostatic sensor electrode is smaller than a third threshold.

11. The input device according to claim 1,
wherein the at least one operation section comprises a plurality of operation sections,
and wherein the processing unit determines, for each of the plurality of operation sections, whether the hand is present above the operation section.

12. The input device according to claim 1,
wherein the at least one operation section comprises a plurality of operation sections, each provided with a corresponding plurality of surrounding electrostatic sensor electrodes disposed therearound,
and wherein the processing unit determines that, the hand is present above one of the plurality of operation sections whose surrounding electrostatic sensor electrode has the largest capacitance value.

13. The input device according to claim 1,
wherein the at least one operation section comprises a plurality of operation sections, each provided with a corresponding plurality of electrostatic sensor electrodes disposed therearound,
and wherein the processing unit calculates and outputs, for each of the plurality of operation sections, a degree of proximity of the hand based on capacitance values of the corresponding plurality of electrostatic sensor electrodes.

14. The input device according to claim 1, wherein the operation section is a push button or a joystick, or the operation section has a circular shape in plan view.

15. The input device according to claim 1
wherein the at least one operation section comprises four operation sections arranged in a cross shape,
and wherein the plurality of electrostatic sensor electrodes include, for each operation section, two driving electrodes disposed opposite to each other and two detection electrodes disposed opposite to each other, such that each of the plurality of capacitance values is obtained as a mutual capacitance between the driving electrode and the detection electrode adjacent to each other.

16. The input device according to claim 1,
wherein the at least one operation section comprises four operation sections arranged in a cross shape,
and wherein the plurality of electrostatic sensor electrodes include, for each of the four operation sections, four electrostatic sensor electrodes each of which provides a self-capacitance value and having a shape that becomes narrower in width toward the operation section.

17. The input device according to claim 1
wherein the at least one operation section comprises four operation sections arranged in a cross shape,
and wherein the plurality of electrostatic sensor electrodes have:
a circular shape;
a trapezoidal shape in which an upper base faces the operation section; or
a hexagonal shape such that a side facing the operation section is bisected perpendicularly by a straight line passing through a center of the operation section.

18. The input device according to claim 16,
wherein the four electrostatic sensor electrodes are arranged to form a cross shape with corresponding one of the operation sections at a center of the cross shape, and
wherein one of the plurality of electrostatic sensor electrodes which is disposed at a position surrounded by the four operation sections is commonly used for the four operation sections to obtain the plurality of capacitance values.

19. The input device according to claim 1
wherein the at least one operation section comprises four operation sections arranged in a cross shape,
and wherein the plurality of electrostatic sensor electrodes include:
one electrostatic sensor electrode disposed at a center position surrounded by the four operation sections; and
four electrostatic sensor electrodes disposed at four corner positions such that each operation section is sandwiched by a pair of electrostatic sensor electrodes.

20. The input device according to claim 1
wherein the at least one operation section comprises four operation sections arranged in a cross shape, including a first operation section and a second operation section opposing each other along a first straight line passing through centers thereof, and a third operation section and a fourth operation section opposing each other across the first straight line,
and wherein the plurality of electrostatic sensor electrodes are provided only on the first straight line, a second straight line parallel to the first straight line and passing through a center of the third operation section, and a third straight line parallel to the first straight line and passing through a center of the fourth operation section.

21. The input device according to claim 1,
wherein the at least one operation section comprises four operation sections arranged in a cross shape, including a first operation section, a second operation section adjacent to the fist operation section on one side, a third operation section adjacent to the first operation section on another side, and a fourth operation section opposite to the first operation section and adjacent to the second and third operation sections,
wherein the plurality of electrostatic sensor electrodes are disposed only on a diagonal lines passing through centers of the adjacent first and second operation sections, a diagonal line passing through centers of the adjacent first and third operation sections, a diagonal line passing through centers of the adjacent second and fourth operation sections, and a diagonal line passing through the centers of the adjacent third and fourth operation sections,
and wherein a width of each of the plurality of electrostatic sensor electrodes in the direction in the diagonal line passing through the electrostatic sensor electrode is smaller than a width in a direction orthogonal to the diagonal line.

22. The input device according to claim 2, wherein when a ratio of two of the plurality of capacitance values is smaller than a second threshold, which is greater than 1, and is greater than a fourth threshold, which is greater than 0 and smaller than 1, the processing unit determines that the hand is present above the operation section.

23. The input device according to claim 22, wherein the fourth threshold is a reciprocal of the second threshold.
